(19) United States
(12) Patent Application Publication
(10) Pub. No.: US 2004/0205818 A1
(43) Pub. Date: Oct. 14, 2004

(54) Education service system using communicate line and education service providing method

(76) Inventors: Nozomu Saruhashi, Osaka-shi (JP); Masahide Uemura, Osaka-shi (JP); Katsunori Shimamoto, Osaka-shi (JP); Yu Yasumi, Osaka-shi (JP)

Correspondence Address: Joseph R Keating, Keating & Bennett, Suite 312, 10400 Eaton Place, Fairfax, VA, 22030, US

(21) Appl. No.: 10/481,769

(22) PCT Filed: Jun. 24, 2002
(86) PCT No.: PCT/JP02/06299

(30) Foreign Application Priority Data
Jun. 25, 2001 (JP) 2001-192063

(51) Int. Cl. H04N 5/445; G06F 13/00; H04N 7/18

(52) U.S. Cl. 725/61; 725/78

(57) ABSTRACT

An educational service using communication lines is provided, in which multimedia educational materials stored in advance, including video images, are delivered online so that a conversation based on the educational materials can be held with an instructor for great educative results. The service includes: a bidirectional communication server (10) for conducting bidirectional multimedia communication; a contents management server (20) for storing multimedia contents; a contents delivery server (12) for delivering the contents stored in the contents management server to user terminals; and administration system (50-56), thus providing face-to-face services and automatic services in combination. The educational service also has the function of conducting lesson evaluations and level check tests automatically. The educational service is also provided with kartes of the members' lesson histories, and has the function of creating personal training point reports and educational plans automatically and the function of extracting additional instruction targets automatically.

### BACKGROUND OF THE INVENTION

1. Field of the Invention

The invention relates to an educational service system and an educational service providing method using communication lines. In particular, the invention relates to an educational service system and an educational service providing method for use in educational services, for example, for providing English conversation and other language educations at remote sites over the Internet (hereinafter, referred to as “Internet study abroad services”).

2. Description of the Related Art

Among conventional educational service systems using communication lines is a video conference system as shown in FIG. 33. In the diagram the reference numerals 1a, 1b, . . . , 1n represent video conference terminals, 2a, 2b, . . . , 2n, and 5a, 5b, . . . , 5n communication lines, 3 a multipoint control unit for multipoint communications, which connects the plurality of video conference terminals over the communication lines, and 4 a reception terminal for conference reception. Each of the video conference terminals includes a display for displaying images, a TV camera for capturing images, a headphone set including a microphone for capturing voice and earphones for hearing, and a personal computer with a built-in TA (terminal adaptor). The video conference terminals are connected with the multipoint control unit 3 and the reception terminal 4 over the communication lines. ISDN telephone lines are typically used as the communication lines for receiving services at home and conducting image communications.

For educational services using this video conference system, students first call the center where the reception terminal is, and place their orders for the services. If the reception terminal confirms that the callers are predetermined students, it connects the corresponding video conference terminals with the multipoint control unit. Instructors also use video conference terminals that are connected to the multipoint control unit. Consequently, the individual students can make bidirectional communications using TV pictures and sounds with the instructors, receiving English conversation and other educational services. In order to handle situations with three or more attendants in a video conference, the multipoint control unit synthesizes the images of the connected video conference terminals for split screen display. This permits each instructor to provide educational services for a plurality of students.

In English conversation classes using such a video conference system, the use of the video conference system with the bidirectional communication function using TV pictures and sounds eliminates the need for the students to go to the English conversation school. This makes English conversation education available at home to students who live away from the school, who do not have time to attend school, and who have difficulties in leaving home due to having small children or parents in need of nursing care. This also permits more flexible scheduling of lessons, which facilitates small-group education by native speakers which is proven to provide greatly improved educational results.

In the educational system using such a conventional video conference system, however, primarily face-to-face conversation services are provided. It is thus been not possible to use the educational system for more sophisticated education such that multimedia educational materials stored in advance, including various types of video images, are delivered and used online.

### SUMMARY OF THE INVENTION

To overcome the problems described above, preferred embodiments of the present invention provide an educational service using communication lines in which multimedia educational materials stored in advance, including various types of video images, are delivered online such that a conversation based on the educational materials can be held with an instructor with greatly improved educational results.

The educational service system using communication lines according to a preferred embodiment of the present invention includes a bidirectional communication device for conducting bidirectional communication between user terminals, using multimedia information including at least TV pictures and sounds, a content management device for storing multimedia content to be used as educational materials, and a content delivery device for delivering the content stored in the content management device to the user terminals.

The educational service providing method using communication lines according to another preferred of the present invention includes the steps of receiving TV pictures and sounds transmitted from the user terminals, synthesizing the TV pictures and sounds received, transmitting the synthesized TV pictures and sounds to the user terminals, storing multimedia content to be used as educational materials, retrieving the stored content, and delivering the retrieved content to the user terminals.

In the educational service providing method using communication lines, the step of storing content preferably includes the steps of storing material content and storing a scenario defining a combination of the material contents along a time axis, and the step of delivering content preferably includes the steps of retrieving the stored material content based on the stored scenario, and delivering the retrieved material content.

This eliminates the need for the prior synthesis and storing of delivery content, and thus, reduces the required memory capacity even when the content to be delivered includes a plurality of material contents which are synthesized.

The educational service providing method according to another preferred embodiment of the present invention includes the steps of establishing a service menu combining a face-to-face service for effecting face-to-face learning by the bidirectional communication device with an assigned instructor and an automatic service for enabling learning under content delivery by the content delivery device with no assigned instructor; and providing services based on the established service menu.

This allows each instructor to control a number of services in parallel, which reduces personnel cost. It is therefore possible to provide services at a lower cost.

The educational service providing method according to another preferred embodiment of the present invention includes a membership information file including personal information regarding members. The method includes the steps of displaying information registered in the membership information file onto an authenticated user terminal, acquiring personal information to be registered or updated from the user terminal, confirming with the user terminal permission to register the acquired personal information into the membership information file, and recording the confirmed personal information into the membership information file.

Consequently, members can register and update their personal information via the user terminals.

In the educational service providing method using communication lines, the step of confirming for permission to register preferably includes the steps of delivering a confirmation mail to the user, accepting a reply mail to the confirmation-mail, and analyzing the accepted reply mail. This prevents erroneous member registration and achieves enhanced security.

The educational service providing method using communication lines preferably includes a bonus score file for accumulating a score for a member to receive a bonus service. The method includes the steps of adding a predetermined score to the score of the member in the bonus score file when the member satisfies a predetermined bonus score occurring condition, notifying the member of the bonus score accumulated and of a free bonus available, and applying for a free bonus based on the notification.

This makes it possible to give members incentives for course promotion, learning, and other purposes.

The educational service providing method according to another preferred embodiment of the present invention includes the steps of delivering content for lesson evaluation to the user terminals, acquiring answers to the delivered content from the user terminals, and calculating lesson evaluations from the acquired answers.

Lesson evaluations are thus obtained even in automatic services.

The educational service providing method using communication lines preferably includes the steps of delivering content for a level check test to the user terminals, acquiring answers to the delivered content from the user terminals, and calculating level check evaluations from the acquired answers.

Level check tests are thus conducted even in automatic services.

The educational service providing method using communication lines preferably includes a karte file including lesson histories for each member. The method includes the steps of recording lesson description and lesson evaluation into the karte file lesson by lesson, and recording level check evaluations into the karte file upon each level check test.

It is therefore possible to determine the statuses of lesson attendance, the lesson evaluations, and the progress of level check evaluations of the members, making it possible to enhance member motivation and avoid discouragement caused by a lack of improvement.

The educational service providing method using communication lines preferably includes a training point report creation table for defining the relationship between lesson evaluations and descriptions in a personal training point report. The method includes the steps of retrieving past lesson evaluation data recorded in the karte, and creating a training point report from the retrieved lesson evaluation data with reference to the training point report creation table.

Consequently, personal training point reports are created automatically without a burden on instructors. It is therefore possible to provide the members with detailed instruction, contributing to improved skills of the members.

The educational service providing method using communication lines preferably includes an educational pattern determination table for determining an educational pattern from evaluation values on evaluation items, and a lesson table for registering a lesson to be attended with respect to each of the evaluation items. The method includes the steps of retrieving past lesson evaluation data recorded in the karte, extracting an item of low evaluation from the extracted lesson evaluation data, determining an educational pattern from the evaluation value of the extracted item with reference to the educational pattern determination table; and combining lessons based on the determined educational pattern with reference to the lesson table.

Consequently, educational plans are created automatically without a burden on instructors. It is therefore possible to provide the members with detailed instruction, contributing to improved skills of the members.

The educational service providing method using communication lines preferably includes an additional instruction target extraction condition table for extracting a member in need of additional instruction. The method includes the steps of retrieving data from the karte, extracting an additional instruction target from the fetched data of the karte with reference to the additional instruction target extraction condition table, and notifying the extracted member.

This permits periodic automatic extraction of additional instruction targets from the kartes for member notification. It is therefore possible to prevent the members from being discouraged and contribute to improved skills of the members.

The foregoing and other objects, features, and advantages of the invention will become more apparent from the following detailed description of an embodiment of the invention when read in conjunction with the drawings.

### BRIEF DESCRIPTION OF THE DRAWINGS

FIG. 1 is a block diagram showing an educational service center according to a preferred embodiment of the present invention;

FIG. 2 is a conceptual diagram showing a video conference function according to the preferred embodiment of the present invention;

FIG. 3 is a diagram showing the procedure for the video conference function according to the preferred embodiment of the present invention;

FIG. 4 is a conceptual diagram showing a data conference function according to the preferred embodiment of the present invention;

FIG. 5 is a conceptual diagram showing a content delivery function according to the preferred embodiment of the present invention;

FIG. 6 is a conceptual diagram showing the method of expressing delivery content in a scenario;

FIG. 7 is a chart showing an example of a scenario for use in the content delivery of the present invention;

FIG. 8 is a diagram showing the procedure for scenario-based content delivery;

FIG. 9 is a diagram showing the procedure for operation control on content under delivery;

FIG. 10 is a conceptual diagram showing a live link function according to the preferred embodiment of the present invention;

FIG. 11 is a conceptual diagram showing a content management database for automatic scenario creation;

FIG. 12 is a diagram showing a sample of description in a scenario dictionary;

FIG. 13 is a diagram showing the procedure for automatic scenario creation;

FIG. 14 is a diagram showing an example of screen display for situations where the conversation function by the bidirectional communication server is effected;

FIG. 15 is a diagram showing an example of screen display for the case of content delivery by the content delivery server;

FIG. 16 is a diagram showing an example of screen display for situations where a conversation is held with content delivery;

FIG. 17 is a chart showing examples of service configuration patterns for combining face-to-face services and automatic services;

FIG. 18 is a chart showing examples of combination of a plurality of services to be taken charge of by a single instructor;

FIG. 19 is a diagram showing an example of a membership information entry screen;

FIG. 20 is a diagram showing the procedure for the authentication and accounting function according to the embodiment of the present invention;

FIG. 21 is a diagram showing an example of a bonus score inquiry screen;

FIG. 22 is a diagram showing an example of a karte entry screen;

FIG. 23 is a sample of a personal training point report;

FIG. 24 is a chart showing examples of comments included in an advice table;

FIG. 25 is a chart showing examples of comments included in a positive evaluation table;

FIG. 26 is a chart showing examples of comments included in a training point table;

FIG. 27 is a chart showing an example of an evaluation value combination table;

FIG. 28 is a chart showing an example of a comment combination table;

FIG. 29 is a flowchart showing an example of the processing flow of a personal training point report automatic creation function;

FIG. 30 is a chart showing an example of a training point report issuing file;

FIG. 31 is a flowchart showing an example of the processing flow of an educational plan automatic creation function;

FIG. 32 is a flowchart showing an example of an additional instruction target automatic extraction function; and

FIG. 33 is a block diagram showing a conventional educational service system.

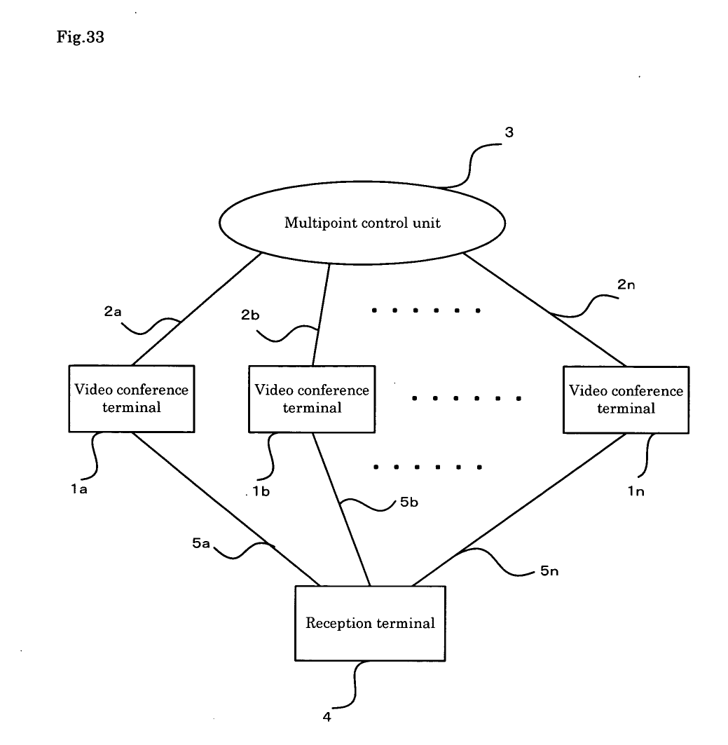

### DETAILED DESCRIPTION OF PREFERRED EMBODIMENTS

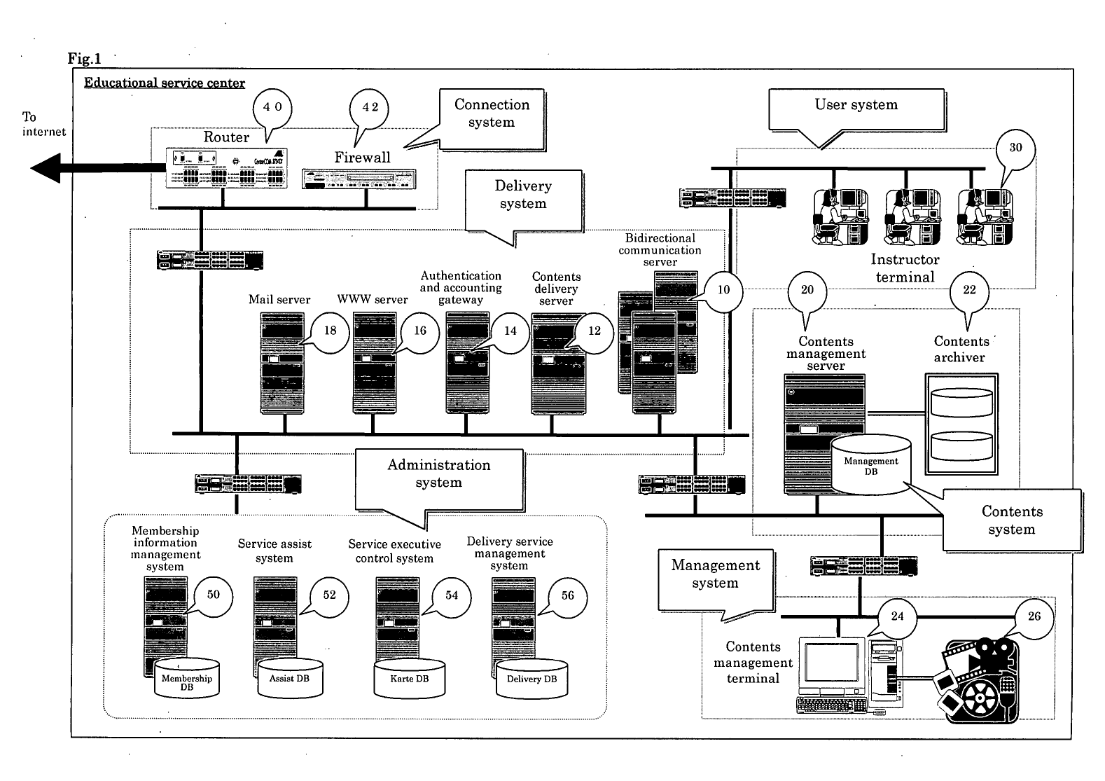

FIG. 1 is a block diagram showing an educational service center according to a preferred embodiment of the educational service system using communication lines according to the present invention. As shown in the diagram, the center is network-connected with the following subsystems.

The Delivery system includes a bidirectional communication server 10, a content delivery server 12, an authentication and accounting gateway 14, a WWW server 16, and a mail server 18. The bidirectional communication server 10 provides bidirectional communication functions among a plurality of user terminals, using multimedia including TV pictures and sounds. The content delivery server 12 delivers content to the user terminals. The authentication and accounting gateway 14 exercises authentication and accounting management in cooperation with administration system. The WWW server 16 delivers Web pages used to authenticate users, selecting service menus, and other components. The mail server 18 delivers educational materials, various notifications, materials, and other mail to the users.

The content system includes a content management server 20, a content archiver 22, a content management terminal 24, and a picture and sound link unit 26. The content management server 20 registers and stores multimedia content such as moving images, still images, sounds, text, and sound effects. The content archiver 22 contains material content. The content management terminal 24 is used to make registration and store operations by the content administrator. The picture and sound link unit 26 is intended to link live pictures and sounds.

The user system includes instructor terminals 30 which are user terminals installed in the center and used primarily by instructors. Each of the instructor terminals 30 includes a TV camera and a microphone for capturing the picture and voice of an instructor, and a computer having an interface function for the TV camera and microphone and a network connection function. The instructor terminals 30 have the function of transmitting the pictures and voices captured by the TV cameras and microphones, and the function of receiving multimedia information from the bidirectional communication server 10 and the content delivery server 12 and outputting the same to screens and speakers. The instructor terminals 30 also have the functions of selecting a screen configuration and a sound allocation on user terminals, and transmitting control signals to control operations for content delivery to the bidirectional communication server 10 and the content delivery server 12.

The connection system includes a router 40 and a firewall 42. The router 40 is provided for Internet connection. The firewall 42 prevents unauthorized entry so as to protect the system.

The administration system includes a membership information management system 50, a service assist system 52, a service executive control system 54, and a delivery service management system 56. The membership information management system 50 manages information regarding the members to be served. The service assist system 52 provides smooth educational service. The service executive control system 54 performs executive control of educational services. The delivery service management system 56 exercises centralized control on the mail delivery to the registered members.

Now, although not shown in the diagram, student terminals, or user terminals used by students, each includes a TV camera and a microphone for capturing the picture and voice of the student, and a personal computer having an interface function for the TV camera and microphone and an Internet connection function. The student terminals access the WWW server 16 in the center to receive Internet study abroad services provided by the center. It should be noted that the student terminals are basically the same as the foregoing instructor terminals 30 in operation except that they are connected with the center over the Internet.

As used in the following description, the “user terminals” refer to both the student terminals and the instructor terminals 30.

Now, description will be given of the functions and the procedures to be provided by the educational service center. Bidirectional Communication Functions Initially, description will be given of the bidirectional communication functions to be provided by the bidirectional communication server 10.

### 1. Video Conference Function

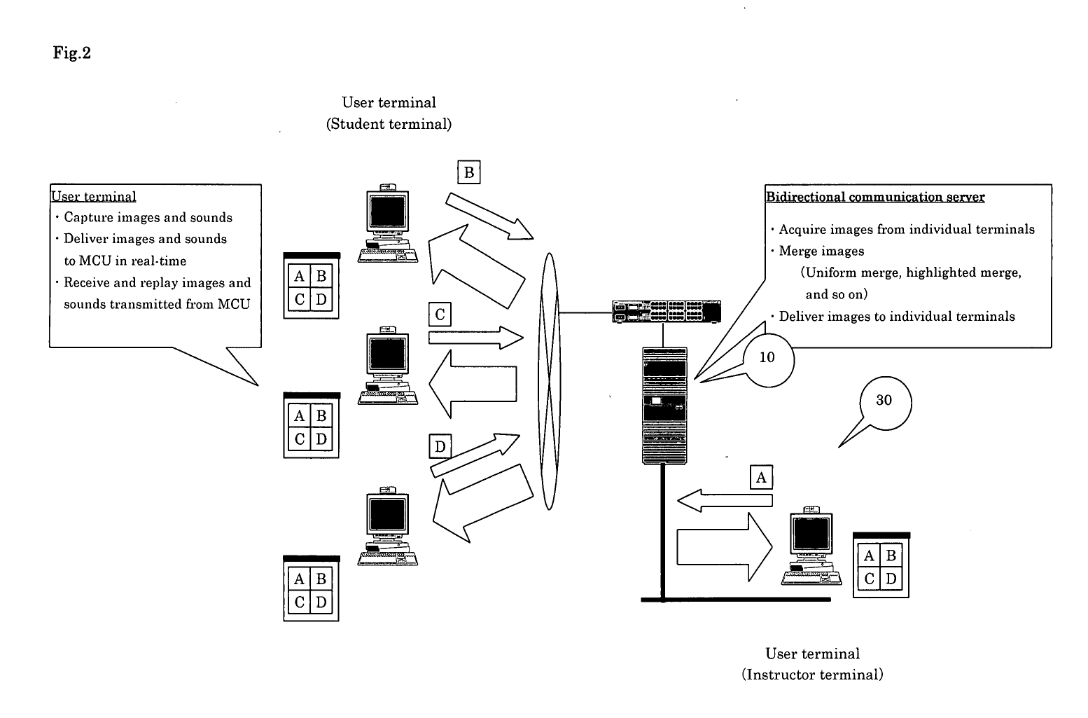

FIG. 2 is a conceptual diagram showing a video conference function to be provided by the bidirectional communication server 10. As shown in the diagram, the video conference function provides one-to-one, one-to-many, or many-to-many bidirectional communications using pictures and sounds captured by the TV cameras and microphones that are connected to the respective user terminals.

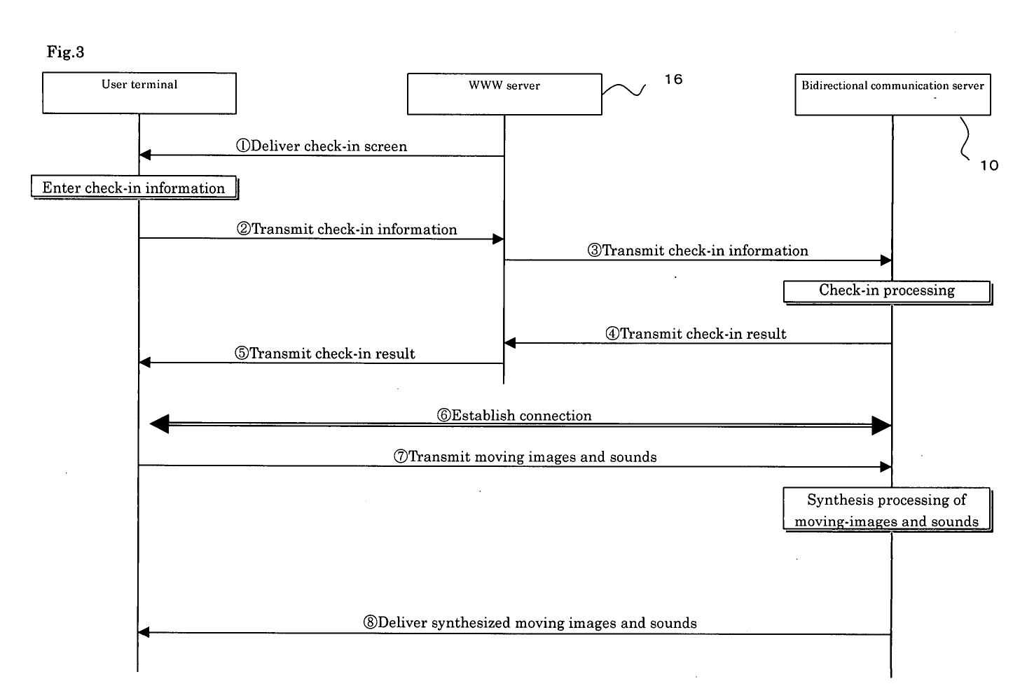

FIG. 3 shows the procedure for the video conference function. User terminals access the WWW server 16 to access a check-in screen. The users enter check-in information, and the user terminals transmit the check-in information to the bidirectional communication server 10 via the WWW server 16. Receiving the check-in information, the bidirectional communication server 10 performs check-in processing and returns the check-in results to the respective user terminals via the WWW server 16. This establishes connections. The individual user terminals capture pictures from the TV cameras and sounds from the microphones, and transmit the captured pictures and sounds to the bidirectional communication server 10 in real time. The bidirectional communication server 10 receives the pictures and sounds transmitted from the individual user terminals, synthesizes the received pictures and sounds into pictures and sounds to be delivered to the respective user terminals, and delivers the synthesized pictures and sounds to the user terminals. The individual user terminals receive the pictures and sounds delivered from the bidirectional communication server 10, create a dedicated window on-screen to display the received pictures, and output the received sounds to their speakers.

The bidirectional communication server 10 thus provides a conversation function among the user terminals, using pictures and sounds. While the conversation function of the present system is of one-to-one or many-to-many in principle, one-to-many service is also available if settings are made at the time of check-in so as to preclude delivery of pictures and sounds other than those from a certain user terminal (for example, a instructor terminal 30).

Buttons for specifying the mode of synthesis of pictures and sounds appear on the screen of the instructor terminal 30. The instructor operates these buttons to transmit the information to the bidirectional communication server 10 such that a uniform merge for synthesizing the pictures and voices of the users uniformly and a highlighted merge for highlighting the pictures and voices of certain users is selected. For example, when a uniform merge is selected in the case of three users or students with a single instructor, the screen is split into four equal sections while the TV pictures of the four are synthesized into a single screen and the sounds of the four are mixed evenly before delivery. When a highlighted merge is selected, the pictures and voices of designated users are selectively delivered. Alternatively, the pictures and voices of the designated users can be made larger than the pictures and voices of the other users before delivery.

Incidentally, the foregoing preferred embodiment describes a the case where both of the modes of synthesis of pictures and sounds are designated by a button operation from the instructor terminal at the same time. Nevertheless, buttons for pictures and sounds may be provided separately to allow separate specification. In this case, for example, it is possible to check attendants' expressions in response to the voices of others.

In the foregoing preferred embodiment, the bidirectional communication server 10 synthesizes pictures and sounds before delivery to the user terminals. Nevertheless, the pictures and sounds of user terminals may be delivered to other user terminals individually such that the respective user terminals create separate windows to display the received pictures along with their own pictures and replay sounds separately. In this case, the user terminals need not receive their own pictures and sounds which have been delivered back to them. This reduces the load on the communication lines. In addition, the users can arrange the screen configuration and sound allocation freely in accordance with their own preferences.

Here, the bidirectional communication server 10 delivers picture and sound control commands from the instructor terminal 30 to the individual user terminals such that the user terminals set the screen configuration and sound allocation based on the control signals.

In the foregoing preferred embodiment, the instructor terminal 30 alone is provided with the function of controlling the screen configuration and sound allocation on each user terminal. Alternatively, the attendant terminals may also be given the function of controlling the screen configuration and sound allocation on each user terminal by the same method. Consequently, even in the absence of one who is in charge of the instructor terminal 30, a chairperson can be selected from among the students. The bidirectional communication server 10 provides a flag for granting the chairpersonship to a user terminal, such that control commands from the flagged user terminal are accepted. This makes services available using any one of the user terminals as the instructor terminal.

Furthermore, the screen configuration of the respective user terminals may be controlled based on the magnitudes of sound transmitted from the individual user terminals. More specifically, for example, the magnitudes of the sound transmitted from the respective user terminals is detected to achieve such screen-configuration control functions that the images of users beyond a certain level are highlighted, and that only the images of users beyond a certain level are displayed selectively. Here, the magnitudes of the sound may be determined in terms of instantaneous values or averages over a certain period of time.

In the case of the method where the bidirectional communication server 10 synthesizes the pictures and sounds of the individual user terminals before delivery to the user terminals, the bidirectional communication server 10 may detect the magnitudes of the sound received from the respective user terminals and control the picture synthesis. On the other hand, with the method where the bidirectional communication server 10 delivers the pictures and sounds of the individual user terminals to the user terminals separately, the destination user terminals may detect the magnitudes of the sound received from the individual user terminals and control screen configuration, or the bidirectional communication server 10 may detect the magnitudes of the sound received from the individual user terminals and deliver screen-configuration control signals to the user terminals such that the respective user terminals control the screen configuration based on the control signals.

Additional functions may also be provided including a voice control function to delay image display and/or sound output slightly achieve an automatic cue, and an anti-trip function to preclude control functions from being activated by speaker sounds.

The quality of the transmission of the pictures and sounds by the respective user terminals and the delivery of the pictures and sounds by the bidirectional communication server 10 may be adjusted depending on the communication band width of the network. To be more specific, a function of detecting the available communication band width and lowering the frame rate of the pictures according to the communication band when the band width is limited is provided. Another function may be provided for lowering the sampling rate and the quantization bit rate of the sounds if the available communication band width is narrow. The communication band may be detected by packet exchange at the stage of negotiation prior to communication, or by sending packets for checking the communication band width during communication. Consequently, even when the communication band width of the network is limited, the bidirectional conversation functions having a quality corresponding to the communication band is maintained for optimum services.

### 2. Data Conference Function

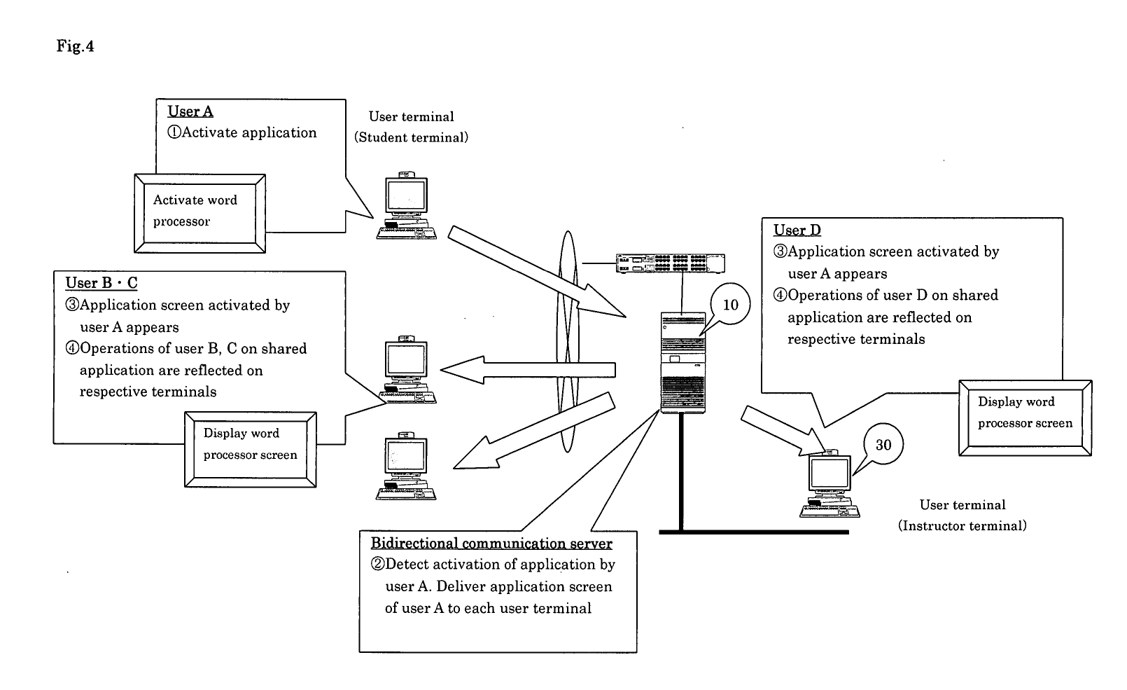

FIG. 4 is a conceptual diagram showing a data conference function to be provided by the bidirectional communication server 10. The data conference function enables application-based cooperative work by sharing applications installed on the individual user terminals or applications on WWW browsers.

For example, as shown in the diagram, when a shared application is activated on the terminal of user A, the terminal of user A transmits the activated shared application screen to the bidirectional communication server 10 successively. The bidirectional communication server 10 delivers the shared application screen from the terminal of user A to the terminals of other users B, C, and D. The terminals of users B, C, and D display the shared application screen delivered from the bidirectional communication server 10. This enables the terminals of users B, C, and D to operate the shared application. Operations are fed back to the terminal of user A via the bidirectional communication server 10. Sophisticated services are thus provided since all the users can collaborate via a word processor, spreadsheet, clip art, and other application programs. For example, it is possible to create a whiteboard on which drawings and characters are written by mouse, and hold a discussion among all the members while writing on this whiteboard.

### 3. Chat Function

Description will now be given of a chat function provided by the bidirectional communication server 10. The chat function provides one-to-one, one-to-many, or many-to-many bidirectional communication by text entries from the user terminals. When a chat program is activated on one of the user terminals, the information is posted to the other user terminals via the bidirectional communication server 10, and the chat screen also appears on the other user's display. When text is entered from any of the user terminals, the entered text is posted to the other user terminals via the bidirectional communication server 10, and the entered text is also displayed on the other user terminals. This enables text-based conversations between the users, making precision- and recordability-requiring services available.

Incidentally, the screen-configuration control function of the instructor terminal 30 (or the chairpersonship-flagged user terminal or the like) described above may also include the function for controlling the screens of the data conference function and chat function in the same manner. This enables the instructor or another user to exercise control for smooth multimedia bidirectional communication services allover.

### Content Delivery Function

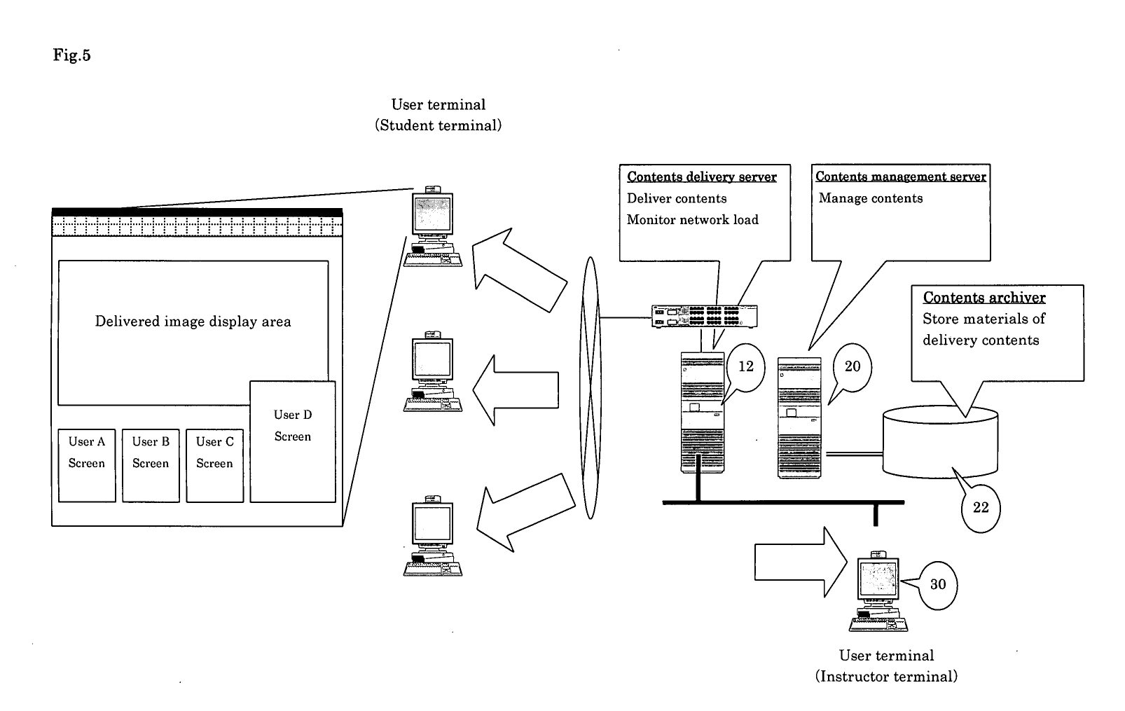

Next, description will be given of the functions and procedure for the content delivery server 12 to provide. FIG. 5 is a conceptual diagram showing a content delivery function to be provided by the educational service system. With the content delivery function, the content delivery server 12 delivers, to the user terminals, multimedia content such as moving images, still images, sounds, text, and application data that are recorded on the content archiver 22 managed by the content management server 20.

In the educational service system of the present invention, the material contents are recorded on the content archiver 22 and combined into content for delivery. For this purpose, delivery content is expressed in a scenario which defines a combination of a plurality of material contents along the time axis.

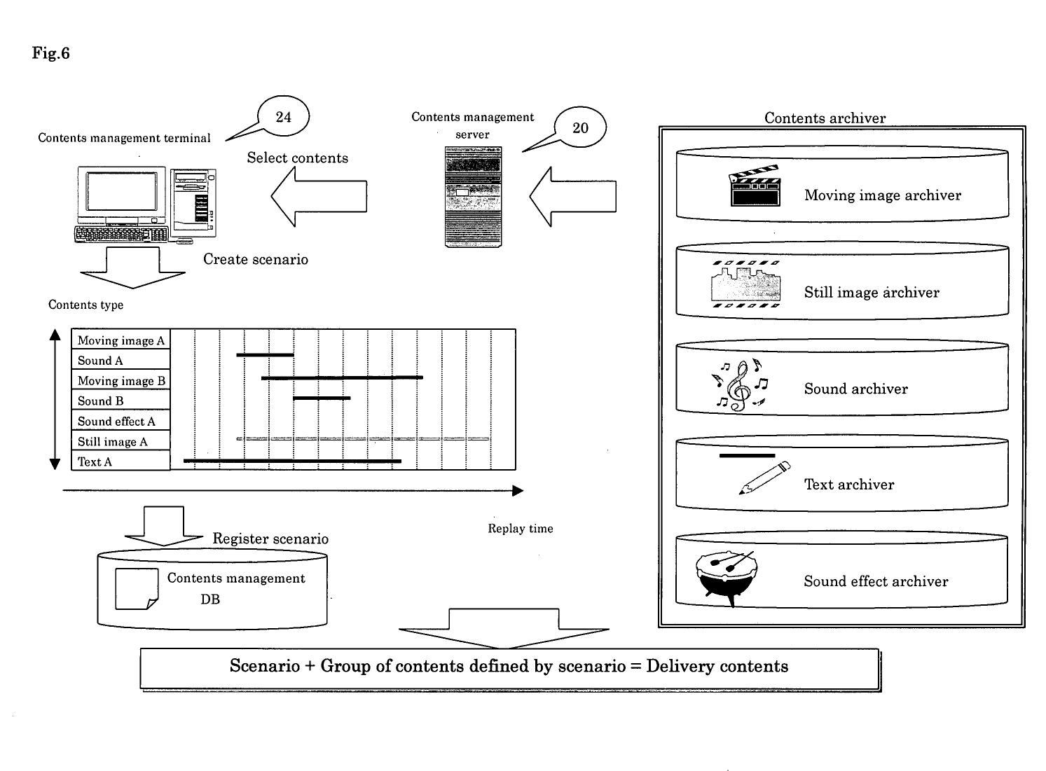

FIG. 6 is a conceptual diagram showing the method of expressing delivery content in a scenario. More specifically, the delivery content creator previously registers the material content necessary for services into the content archiver 22 via the content management server 20 by using the content management terminal 24. At the time of creation of the delivery content, the material content to be combined into the delivery content is selected out of the material contents recorded on the content archiver 22. As shown in the diagram, by using a chart which indicates the replay times of the material content, or a replay chart, the material contents to be combined are registered along the time axis to create a scenario. The created scenario is registered into a database of the content management server 20.

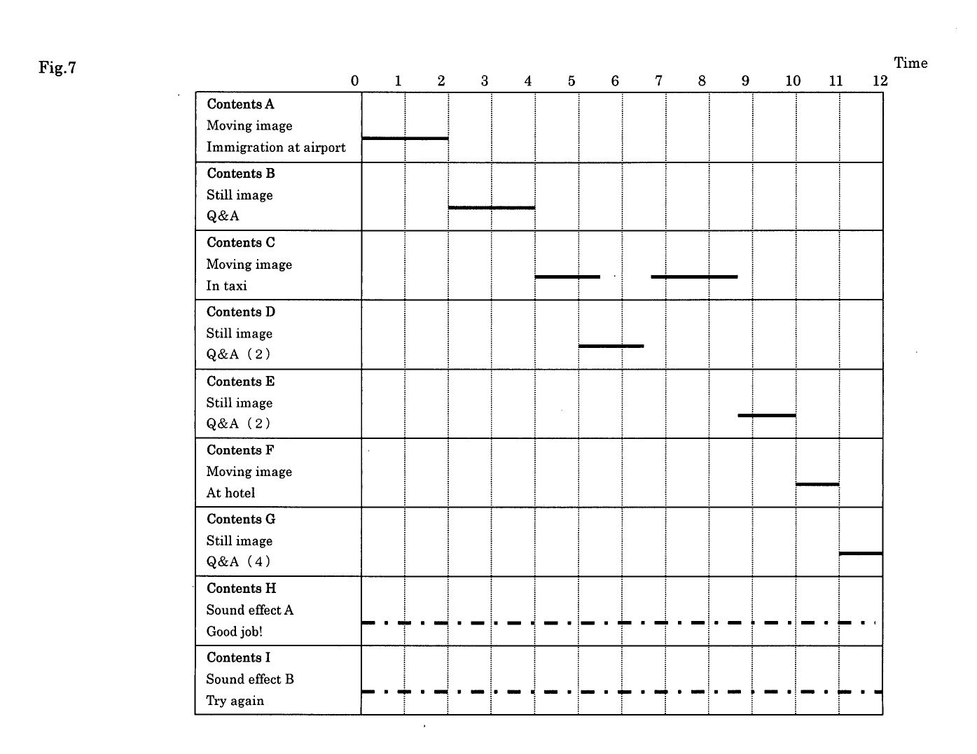

FIG. 7 shows an example of the scenario created. As shown, a combination of moving images, still images, sound effects, and other content is defined along the time axis to define a single piece of delivery content. Here, the dotted-line expressions represent ones which can be replayed by operations from a certain terminal anytime within a specific period. Consequently, for example, the instructor can replay sound effects, subtitles, and other content anytime within a specific period for effective presentation. Information Included in Scenario

A scenario includes the following information in order to achieve delivery of a combination of material content and allow flexible administration.

### 1. Definition of Delivery Content

Information as to the entire content for delivery is defined.

(1) Delivery Content Attribute Information

Describes creator, creation date and time, title, genre, and additional information. This enables retrieval of the delivery content (scenario).

(2) Used Material Content Information

Specifies material content to be used in the delivery content.

### 2. Definition of Material Content

Information as to each piece of the material content to be used in the delivery content is defined.

(1) Material Content Attribute Information

Describes creator, creation date and time, title, genre, and additional information. This permits retrieval of the delivery content (scenario) based on the attributes of the material content used.

(2) Material Content Type Information

Specifies the type of material content (moving image/still image/sound/text/application data). Here, the filename extension of the designated material content is used to specify the type of material content.

(3) Replay Time Specification Information

Specifies the replay start time and replay end time of the material content in terms of relative time within the delivery content. This specifies the replay period of the material content within the delivery content. A replay time may be used instead of the replay end time.

Here, the replay end time/replay time may be omitted if the material content have a fixed replay time.

(4) Replay Mode Specification Information

Specifies the mode of replay of the material content between automatic replay and manual replay. In the case of manual replay, the content is replayed under the instruction from the user terminal. For example, this makes it possible to replay sound effects, subtitles, and other content at arbitrary times for effective presentation.

(5) Replay Application Specification Information

Specifies which application is used to replay the material content. The application for replaying the material content is thus defined by the scenario. Here, the filename extension of the designated material content is used to specify the application for replaying the material content.

(6) Replay Screen Specification Information

Specifies the position and size of the material content replayed on-screen. The position and size of the material content under replay on-screen is thus specified for effective presentation. For sounds, an icon to be displayed on-screen and the position thereof is specified.

(7) Instructor Terminal Operation Specification Information

Specifies operations (play/stop/pause/fast forward/rewind, etc.) available for the instructor terminal 30 (or a chairpersonship-flagged user terminal) during the replay of the material content. The instructor thus controls content replay in accordance with the progress of the service, enabling various service modes.

(8) Student Terminal Operation Specification Information

Specifies operations (play/stop/pause/fast forward/rewind) available for the student terminal during the replay of the material content. This enables students to replay the content according to their own pace.

(9) Location Specification Information

Specifies the storage location of the material content. This makes it possible to replay the material content by designating a protocol and server name even if the user terminal does not contain the material content. Material contents managed in a plurality of centers can also be used for content delivery. Moreover, the picture and sound link unit 26 provides a live link when the content management server 20 is specified as the location.

(10) Replay Portion Specification Information

Specifies the start time and end time of the portion of the material content to replay. This enables specifications for partial replay of the material content. A replay time may be used instead of the end time.

### Method of Scenario-Based Content Delivery

Next, description will be given of the method of delivering content by using the scenario described above.

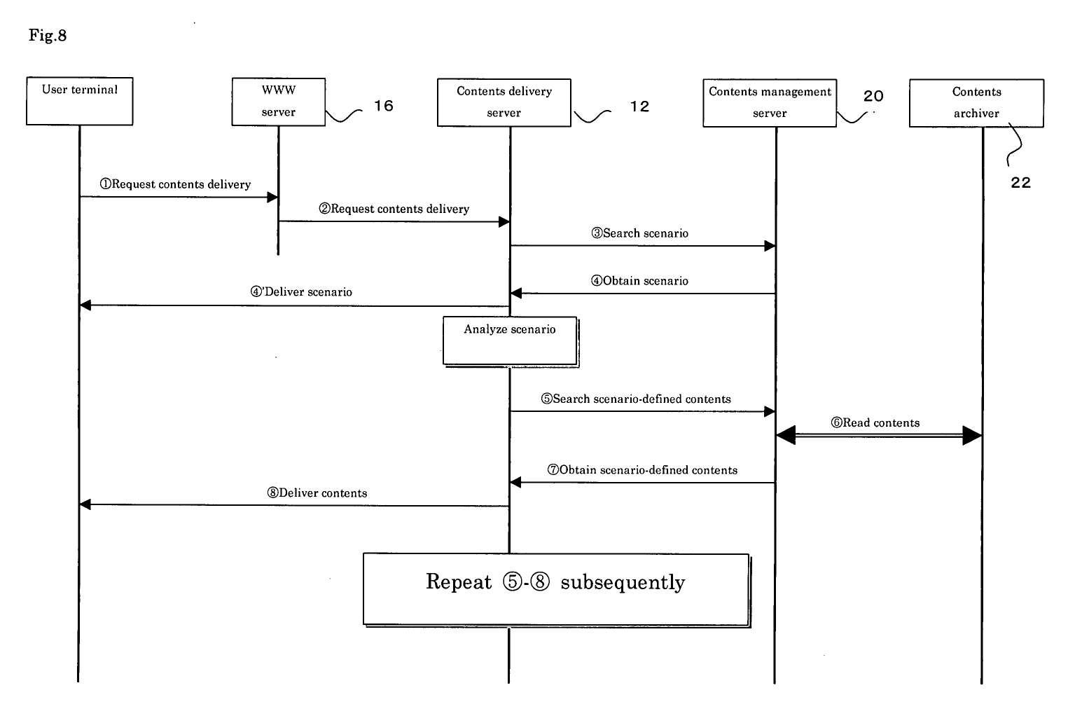

FIG. 8 shows the procedure for scenario-based content delivery. The content delivery server 12 receives a content delivery request from a user terminal via the WWW server 16, and obtains the scenario from the content management server 20. The content delivery server 12 also delivers the obtained scenario to the user terminal so as to control the user terminal. Subsequently, the content delivery server 12 analyzes the scenario, retrieves the material content defined in the scenario from the content archiver 22 via the content management server 20 in succession along the time axis, and delivers the same to the user terminal. These operations are performed for all of the material contents defined in the scenario to complete the delivery of the delivery content.

The destination terminal receives the delivered content, and replays the same by using designated applications according to the description of the scenario, such that images are displayed in the specified positions on-screen. When a specific operation is specified by the instructor terminal 30 or a student terminal, a predetermined replay control is performed under the command from that terminal.

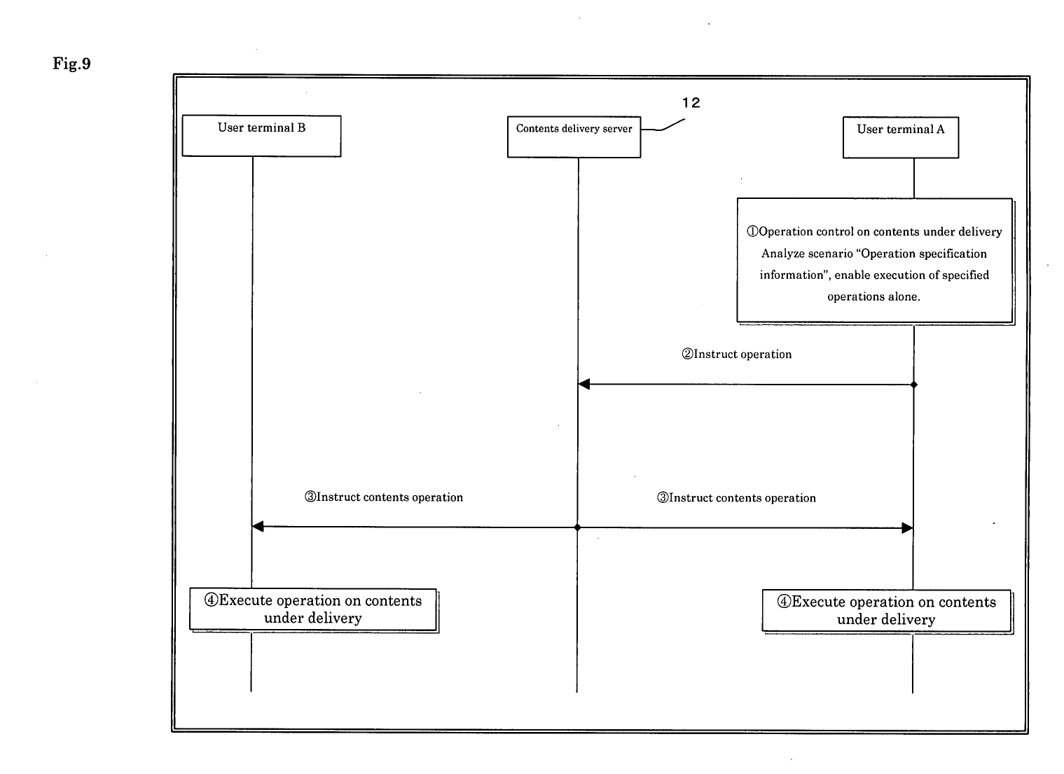

Now, description will be given of the synchronization of replay of material content between terminals. FIG. 9 shows the procedure for operation control delivered content. As shown in the diagram, when an operation instruction for a possible operation is issued from an operable terminal based on the operation specification information of the scenario, it is posted to the content delivery server 12. The content delivery server 12 delivers the operation instruction to each terminal. In order to perform replay based on the operation instruction, all the terminals replay the material content in synchronization with each other.

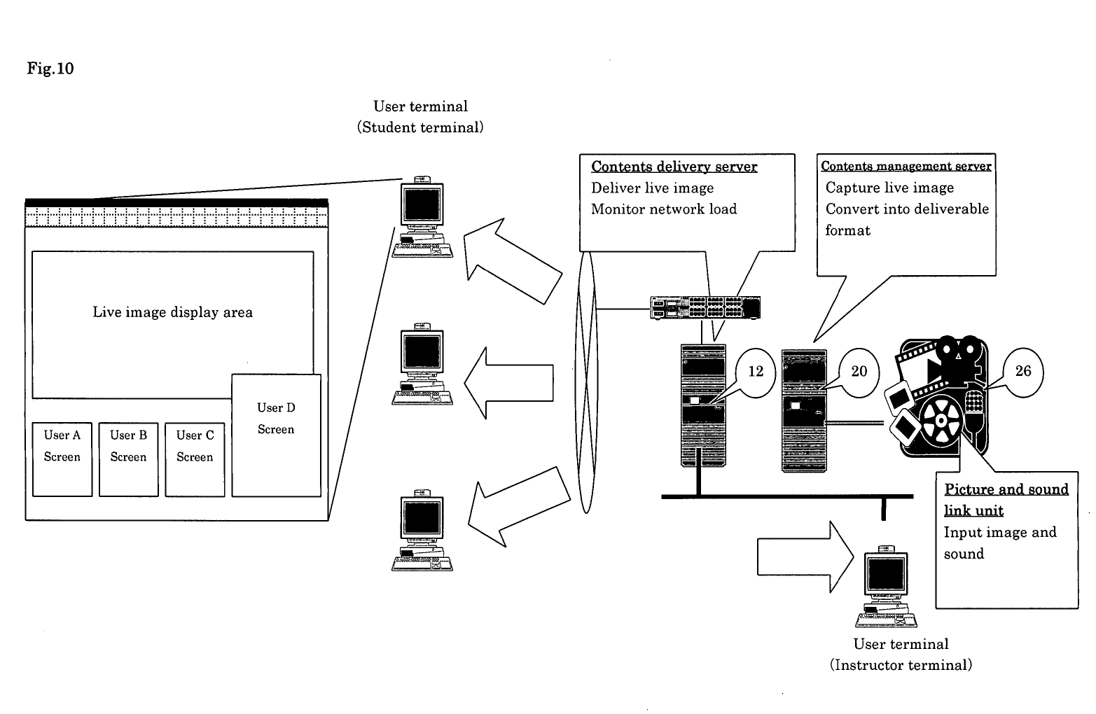

The content management server 20 is provided with the picture and sound link unit 26, and captures picture signals and sounds signals connected thereto and converts the same into deliverable formats. This enables real-time link of live pictures and sounds to the content to be delivered. FIG. 10 is a conceptual diagram showing the live link function.

When the content to be delivered are moving images, streaming delivery is performed. Like the bidirectional communication server 10, the content management server 20 modifies the frame rate of the moving images according to the communication band width of the network. The content management server 20 may also modify the sampling rate or quantization bit rate of sounds according to the communication band width of the network if the content to be delivered are sounds. Consequently, even when the communication band width of the network is limited, the quality of the content delivery function is maintained corresponding to the communication band width to provide optimum services.

In the foregoing preferred embodiment, the content delivery server 12 initially transmits the scenario to the destination terminal(s), and then delivers the material content at the respective replay times defined in the scenario such that the destination terminal(s) performs replay based on the scenario. Nevertheless, the destination terminal(s) may issue requests based on the scenario that the content delivery server 12 deliver necessary material content. In this case, if identical material content is repeatedly used, the material content previously delivered is reused to reduce the network load.

The content delivery server 12 may deliver images and sounds that are synthesized according to the scenario, instead of delivering the individual material contents to the destination terminal(s). This facilitates such operations as superimposing subtitles on moving images and still images. This also reduces the load on the destination terminal(s), but limits the operation flexibility in the destination terminal(s). Which method to adopt, delivering individual material contents or synthesized ones, may be selected depending on the network load and the service content. Both types of content may be delivered in combination, and replayed in respective separate windows on the destination-terminal side. This makes it possible to provide a content delivery function of extremely high flexibility while suppressing network load.

The scenario described above may be written in XML or other description languages. This enables the individual terminals to read the scenario with their browsers, such that material content can be selected along the time axis and replayed automatically by plug-in applications of the browsers.

### Method of Scenario Creation

Next, description will be given of the method of creating the scenario described above.

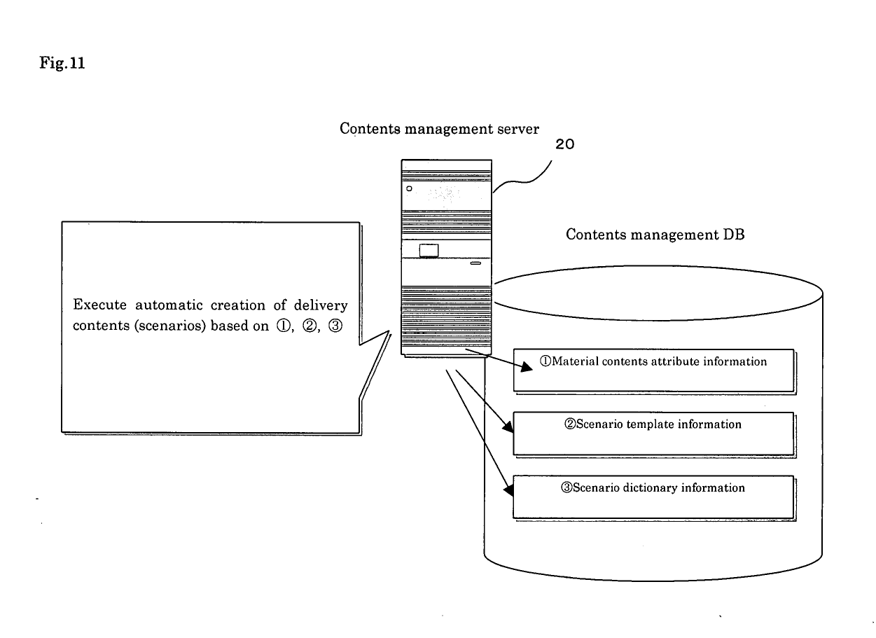

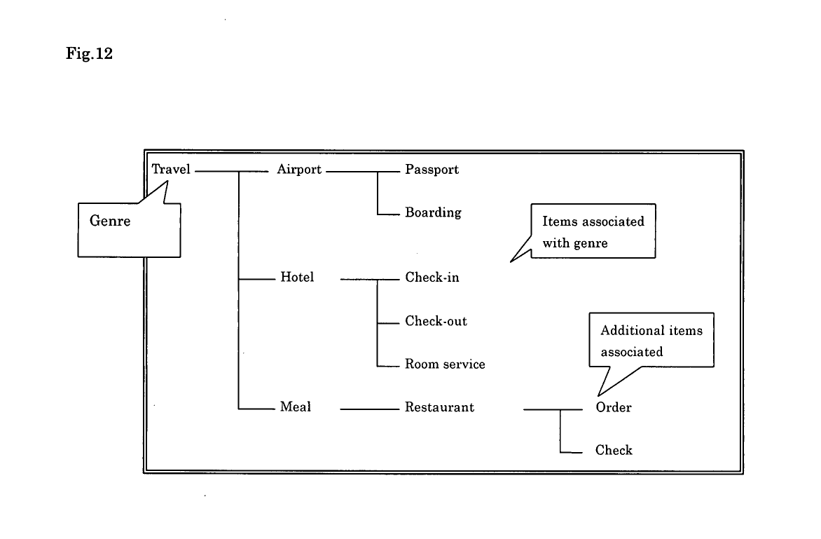

In this educational service center, as shown in FIG. 11, the content management database of the content management server 20 includes attribute information, scenario dictionaries, and scenario templates. The attribute information concerns the material content that is stored in the content archiver 22. The scenario dictionaries show the relationship of the types of educational materials, or genres, with associated information. The scenario templates describe basic configuration patterns of scenarios. Then, the content management server 20 creates scenarios automatically based on the attribute information, the scenario dictionaries, and the scenario templates. FIG. 12 shows a sample of description in a scenario dictionary. As shown in the diagram, associated information for a single genre is written in a tree form. Such scenario dictionaries are prepared in advance so as to cover the attribute information of the registered material content. The scenario templates describe genres, replay time, and the numbers of material contents, as well as the attribute information, type information, replay time information, operation information, and other information of the material content. The scenario templates are created and registered for necessary patterns in advance.

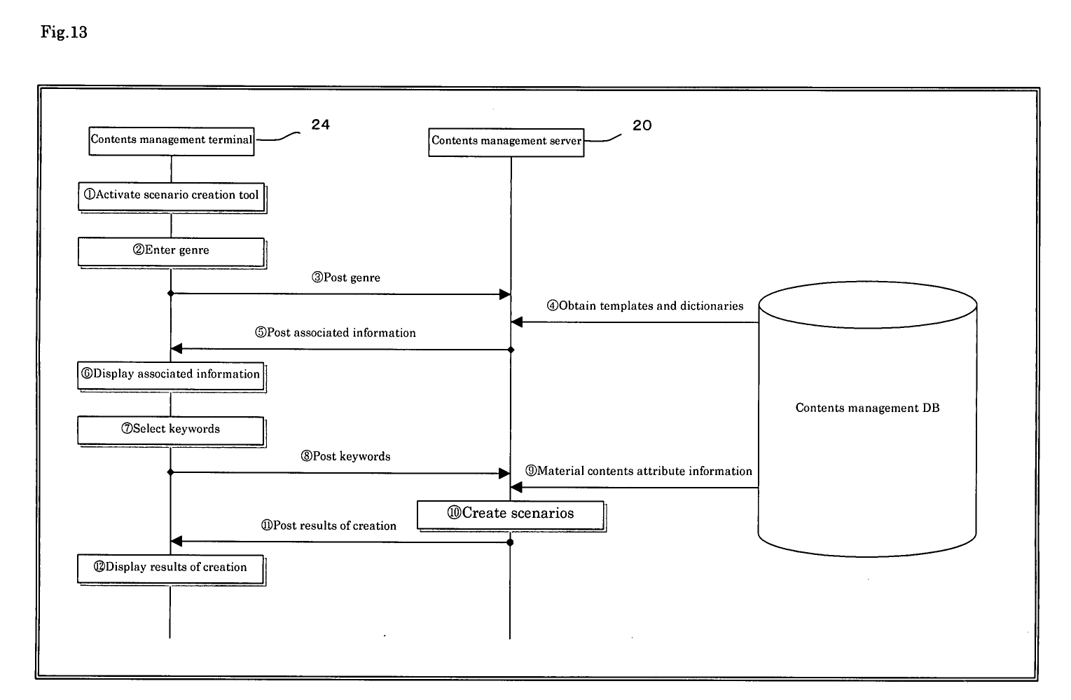

FIG. 13 shows the procedure for creating scenarios automatically by using the content management database mentioned above. The scenario creator activates a scenario creation tool from the content management terminal 24. When a genre is entered by the scenario creator, the content management terminal 24 posts it to the content management server 20. The content management server 20 retrieves scenario templates and a scenario dictionary conforming to the posted genre from the content management database. It also retrieves associated information from the scenario dictionary based on the genre and posts it to the content management terminal 24. The content management terminal 24 displays the associated information posted, and posts keywords that are entered by the scenario creator based on the display to the content management server 20. The content management server 20 retrieves the material content corresponding to the scenario templates based on the keywords posted, and obtains attribute information thereof. The content management server 20 creates scenarios by transcribing the obtained attribute information of the material content into the corresponding positions of the scenario templates, and posts the results of creation to the content management terminal 24. The content management terminal 24 displays the results of creation, modifies and edits the same if needed, and registers the completed scenarios into the content management database of the content management server 20.

As described above, the scenarios are created automatically in this educational service system, and new educational materials incorporating up-to-date topics is rapidly provided for educational service.

In the foregoing preferred embodiment, the scenario templates are selected by entering a genre alone. It is also possible, however, to designate the replay time or the ratios of content types in the replay content. Moreover, in order to inform the scenario creator of possible genres, replay times, and content ratios in advance, the information regarding the registered scenario templates may be displayed such that selections are made from the same.

In the foregoing preferred embodiment, the scenarios are created automatically by using the scenario dictionaries which describe the relationship between genres and associated information, and scenario templates which describe scenario configuration patterns for creating scenarios. However, the scenarios need not necessarily be created automatically. The scenario creator may enter keywords, retrieve related material content based on the same, and write the attribute information of the retrieved material content in the form of scenario data. In this case, necessary material content is quickly retrieved so as to improve the efficiency of scenario creation. Incidentally, the attribute information of the material content may be written into scenario data by a text editor.

The scenario dictionaries may be used alone to retrieve associated information based on the genre entry. Then, the material content is retrieved based on the associated information, and the attribute information of the retrieved material content is written into scenario data. Necessary material content is thus retrieved more quickly than in the case of entering keywords, which further improves the efficiency of scenario creation.

In addition, the replay time specification information of the material content may be set by using a replay chart which shows the replay periods of the respective pieces of material content. For example, as shown in FIG. 7, a minimum unit time for replaying material content may be determined in advance such that the replay time specification information is set by selecting frames for replaying the material content on-screen. This facilitates setting the replay time specification information of the material content and clarifies the interrelationship among the replay periods of the respective pieces of material content, which enables effective content creation.

Scenario templates may be selected based on the genre entry among scenario templates. Here, a list of material content conforming thereto is displayed, and desired material content is selected from the list. This automatic retrieval of material content conforming to scenario templates facilitates combining the material content. The attribute information of the material content may be transcribed to the scenario data automatically to dramatically improve the efficiency of scenario creation.

While the foregoing preferred embodiment describes the case where the scenario templates describing basic scenario patterns are created in advance, scenarios registered previously may be used as scenario templates. This makes it possible to create scenarios without preparing scenario templates in advance. This also facilitates creating scenarios of modified content easily based on the scenarios registered previously.

Now, description will be given of the screen display on a user terminal under educational service using the bidirectional communication functions and the content delivery function.

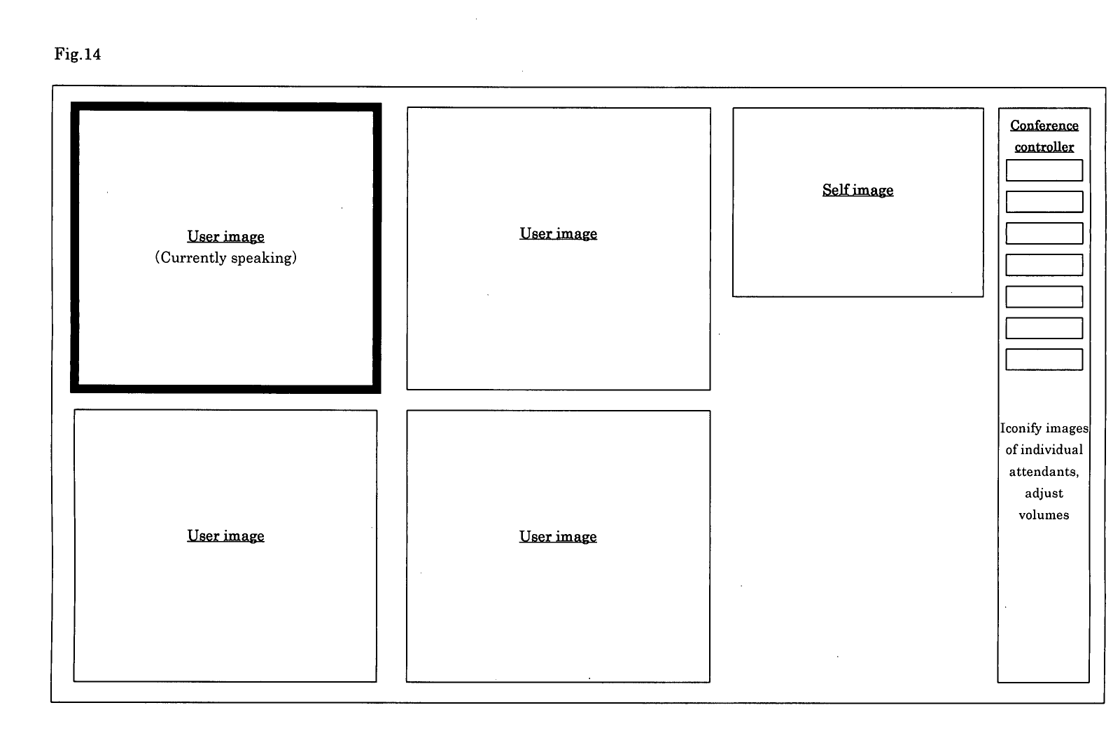

FIG. 14 shows an example of screen display when the conversation function of the bidirectional communication server 10 is used alone. This example of screen display is for situations with five users including the instructor. Windows for displaying the images of the other users and a window for displaying the image of the user himself/herself are created on-screen. Here, the screen includes buttons for controlling the video conference function. These buttons are used to performed the above-described controls on screen configuration, sound allocation, and other operations. As mentioned previously, the windows of users currently speaking are to be highlighted.

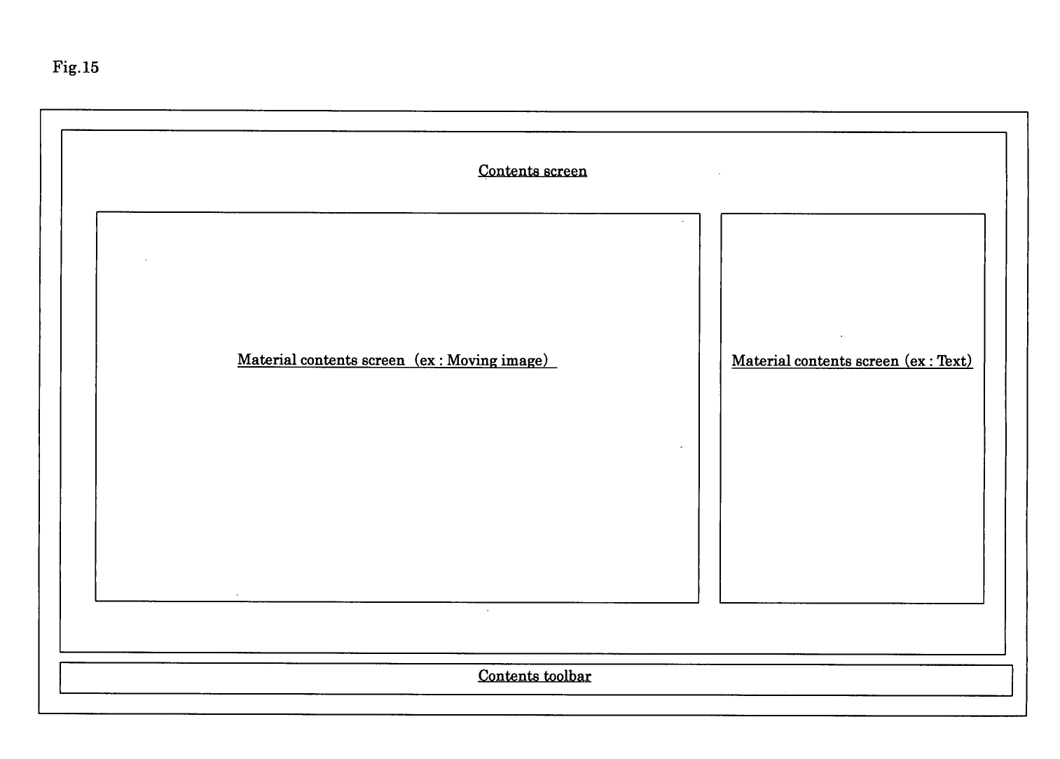

FIG. 15 shows an example of screen display when content delivery by the content delivery server 12 is effected alone. Here, a moving-image window and a text window are created and displayed separately. Nevertheless, the windows may be synthesized on the content-delivery side and transmitted as subtitled display.

A content toolbar is also provided, which is actively displayed when operable for content play, stop, pause, fast forward, rewind, and other operations, for example. These operations can be made based on the operation specification information of the scenario described above.

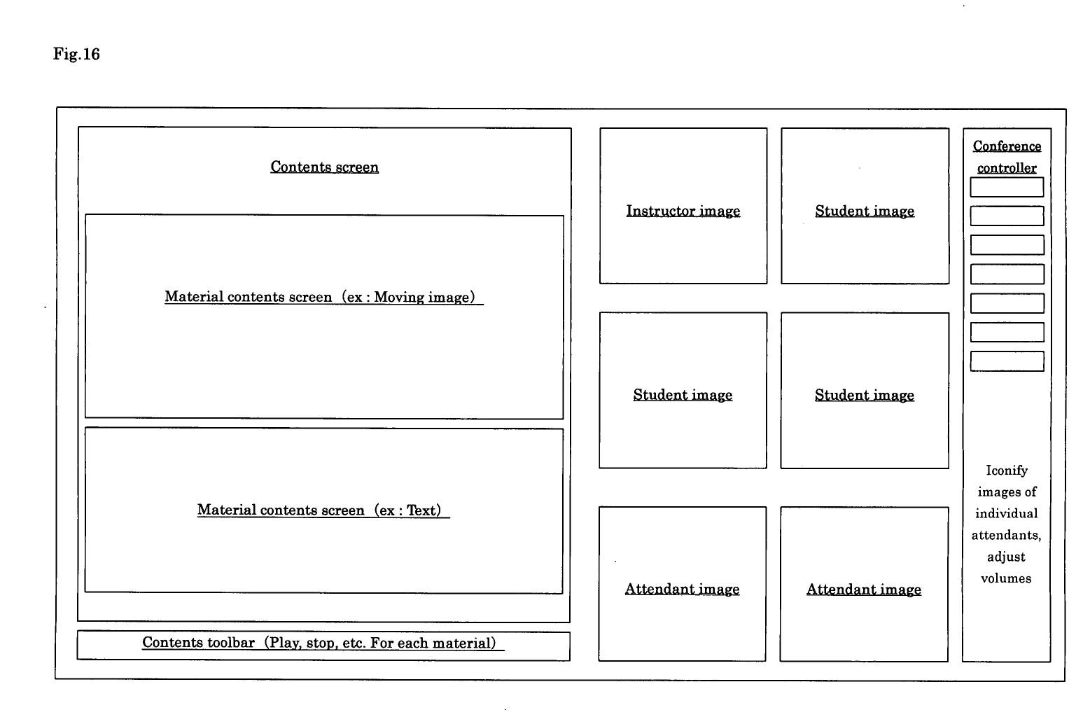

FIG. 16 shows an example of screen display when conversations via the bidirectional communication server 10 are conducted under content delivery by the content delivery server 12. As shown, the attendants can face one another while receiving content delivery for effective learning. Here, it is also possible to operate the conference control buttons for screen display and the toolbar for content replay.

### Mode of Service Provision

Next, description will be given of the modes of services to be provided by the system of the present preferred embodiment. This educational service system includes both the bidirectional communication functions and the content delivery function, and thus provides the following two modes of services.

### 1. Face-to-Face Service

In the presence of an instructor, students can hold conversations with the instructor via the bidirectional communication server 10, under content delivery service by the content delivery server 12 if necessary, to study.

### 2. Automatic service

In the absence of an instructor, students can receive content delivery service by the content delivery server 12 independently to study.

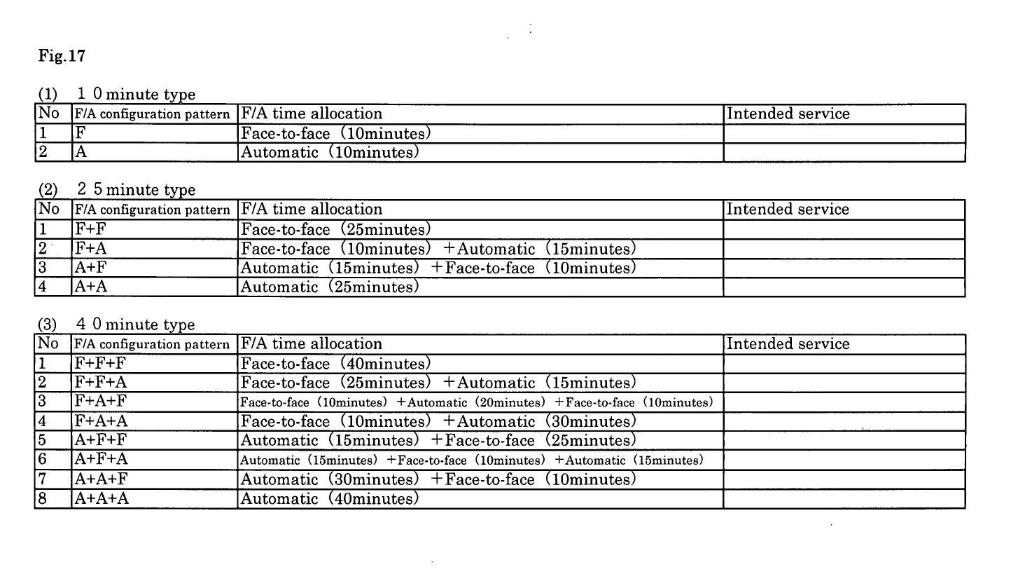

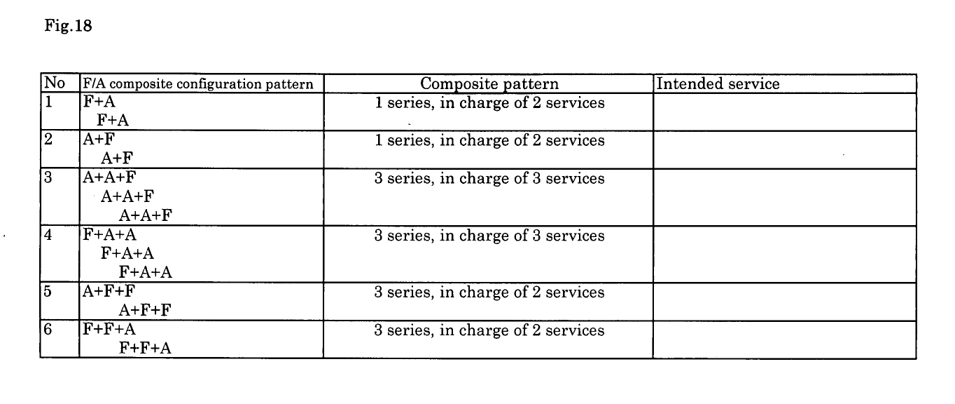

Then, this educational service system is configured to provide services based on service menus which offer face-to-face services and automatic services in combination, with a basic unit of service of 15 minutes and a preparation time of minutes for an instructor or others. FIG. 17 shows examples of service configuration patterns for 10-minute type, 25-minute type, and 40-minute type. In the diagram, F represents a face-to-face service, and A an automatic service. Since service menu files can include combinations of face-to-face and automatic services, an instructor can control a plurality of services as shown in FIG. 18. This enables each single instructor to control a number of services in parallel, which reduces personnel cost. It is therefore possible to provide interactive services for small groups by native speakers at a reduced cost.

The system of the present invention can also provide the following services.

### 3. Group Debate Service

A plurality of students can hold mutual conversations via the bidirectional communication server 10 without an instructor, with content delivery service by the content delivery server 12 if necessary, to study.

### 4. Free Talk Service

A freely-accessible conference room is opened full-time, such that students can access this conference to have conversations with the instructor and other students via the bidirectional communication server 10, with content delivery service by the content delivery server 12 if necessary, to study.

This enables the members to use knowledge acquired in ordinary lessons for capability improvement and receive a “shower” of foreign language to compensate for a shortage of communication, which produces similar effects to actually living in foreign countries. The members can thus study with various modes of services in free combination to achieve great educational results easily while staying at home.

### Function of Administration System

Now, description will be given of the functions and procedure of the administration system.

The administration system is in charge of service provision. To improve the efficiency of administration, maintain service quality, and enhance the mechanism for accepting members to be served, the administration system includes the membership information management system 50, the service assist system 52, the service executive control system 54, and the delivery service management system 56.

### 1. Membership Information Management System

The membership information management system 50 manages information on the members who receive the “Internet study abroad service.”

(1) Member Registration Function

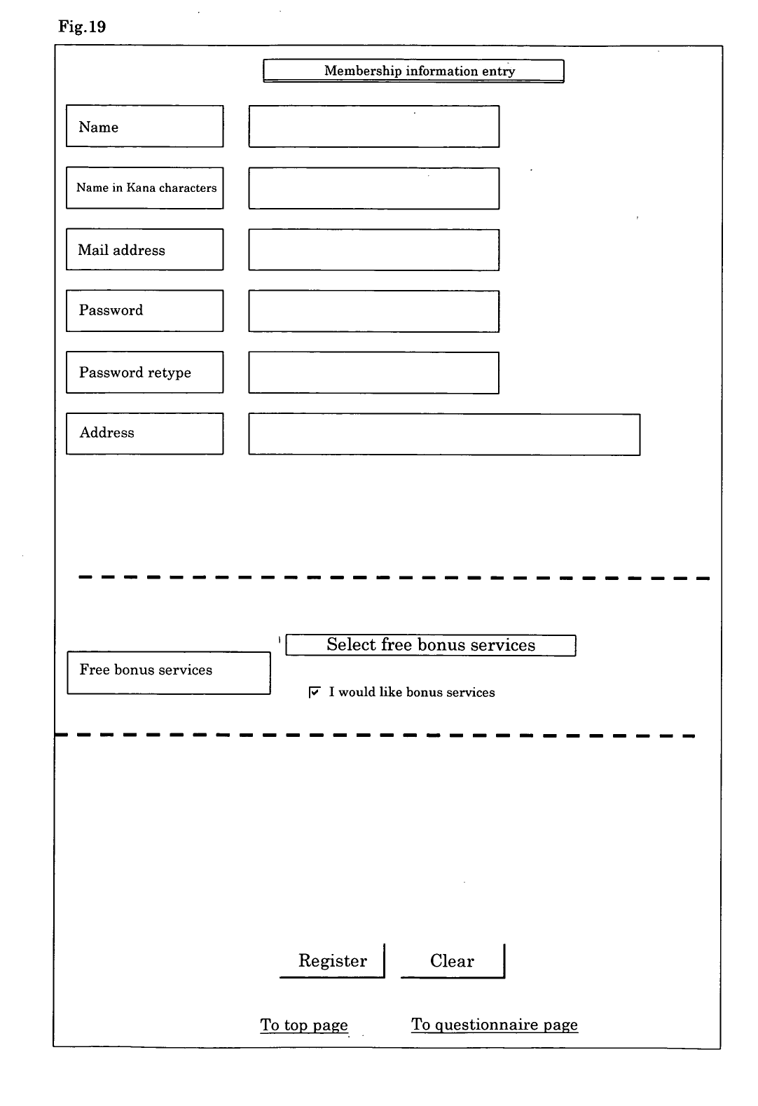

Accepts registration of membership information from a “Membership information registration” page on the “Internet study abroad service” Web site. FIG. 19 shows an example of a membership information entry screen. When the membership information management system 50 accepts registration, it issues ID and a password, and sends a confirmation mail describing the issued ID, password, and the entered membership information to the one who entered the information. When the membership information management system 50 receives from the member a reply mail that confirms that there are no errors in the confirmation mail, it actually registers the ID, password, and entered information to its membership information database. In this manner, the registration information is confirmed mail to prevent erroneous member registration and to enhance security.

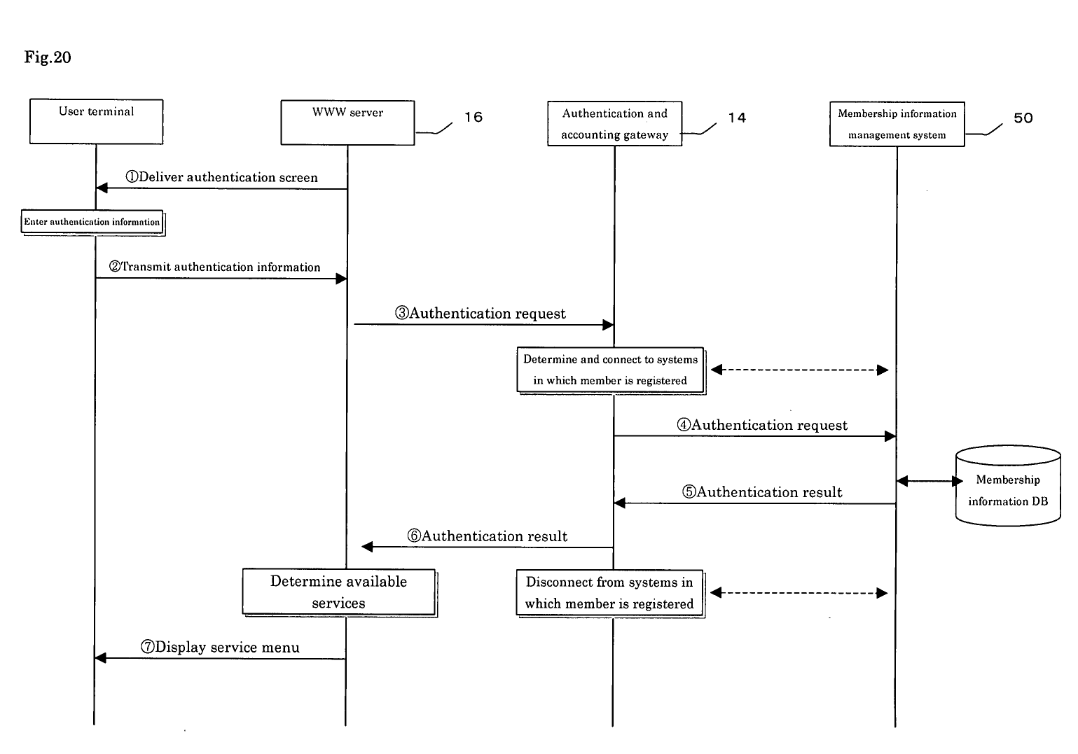

After registration, the ID and password can be used to receive necessary member services on the Web site. FIG. 20 shows the procedure for performing member authentication and accounting by using the ID and password obtained through the member registration. When the member accesses a member service page of “the Internet study abroad service” provided on the WWW server 16 from his/her user terminal, an authentication screen is delivered. Here, the ID and password are entered, and the membership information management system 50 checks the authentication information via the authentication and accounting gateway 14. The membership information management system 50 consults the membership information database and posts the result of authentication to the WWW server 16. From the result of authentication, the WWW server 16 determines which services are available, and delivers the corresponding service menu to the user terminal.

While members are served through the authentication and accounting gateway 14, accounting on the members is performed. This information communication service system has the following three modes of accounting in view of the particularities of the services to be provided.

A first mode is to charge based on the connect times of user terminals. This mode is performed by measuring the elapsed time from the confirmation of authentication by the authentication and accounting gateway 14 to disconnection at the completion of service. Consequently, charges are summed up separately even if the connect times vary from user to user.

A second mode is to charge based on the connect time of the instructor terminal. This mode measures the time for which user terminals are checked in with the instructor terminal 30 and the bidirectional communication server 10, and posts the time to the authentication and accounting gateway 14 after the completion of service. This provides charging based on the actual service time of the instructor.

A third mode is to charge based on the content delivered. This mode obtains the charge information on content delivered from the content management server 20 when the content delivery server 12 delivers the content to user terminals, and posts the charge information to the authentication and accounting gateway 14 after the completion of service. This provides charging according to the content delivered.

As described above, this educational service system has the three modes of accounting and can combine these three modes for charging depending on the services. It is therefore possible to set appropriate charges in accordance with the services to be provided.

(2) Registration Information Inquiry and Modification Function

Makes inquires and modifications of the membership information registered. Again, when the membership information is modified, a confirmation mail describing the entered information is sent to the member. Actual registration is conducted after receipt of a reply mail confirming that there are no errors in the confirmation mail.

Incidentally, this function permits the members to change their passwords as needed, thereby providing protection against unauthorized access by others.

(3) Questionnaire Management Function

Accepts entries to questionnaires on a “Questionnaire” page on the “Internet study abroad service” Web site. The membership information management system 50 receives the entries to the questionnaires, and registers the entered information to its questionnaire database.

(4) Service Point Management Function

Manages points for member services. This educational service system performs accounting of deposit type in order to avoid troublesome service-by-service money reception. Service points can be refilled only by the bureau which has a certain ID and password. When the reception of money from a member is confirmed, service points, corresponding to the amount of money, are added. For withdrawals, service points corresponding to the services to be provided are withdrawn automatically upon receiving notices from the service assist system at the time of service reservations. Incidentally, when services are cancelled, points are returned for notices from the service assist system according to predetermined conditions.

The members can check their current services points anytime by using the membership information inquiry function. When the service points fall to or below certain levels, the members are informed of it automatically by mail. As a result, the members are aware of their remaining service points anytime to avoid such troubles as unavailable services due to underpayment.

Incidentally, in the foregoing preferred embodiment, the service points are added when receipt of money is confirmed by the bureau. Alternatively, members may request to refill service points on the Web site or by mail such that the amount of money corresponding to the points may be withdrawn from the members' bank accounts based on the requests. In this case, the points are added upon confirmation of the withdrawal.

(5) Bonus Score Management Function

Manages scores acquired by members who want free bonus services (referred to as “bonus scores”) The membership information management system 50 grants additional bonus scores in any of the following cases:

(i) On Purchase of Service Points

The additional scores may be proportional to the purchased points, or increased stepwise.

(ii) After a Lapse of Predetermined Dates Since Member Registration

The additional scores may be proportional to the elapsed dates, or increased stepwise.

(iii) At a Predetermined Number of Times of Course Participation

The additional scores may be proportional to the number of times of participation, or increased stepwise.

(iv) For Questionnaire Answers

(v) In Promotion Periods

Certain additional scores may be granted for every member. Some scores may be added when predetermined conditions for the “Internet study abroad service” are met within a specific period. For example, kartes to be described later may be consulted to extract such members as those who consume services intensively, who have taken level check tests by recommendation of instructors, who improve beyond a certain level in evaluations of level check tests, and who are registered newly, such that additional bonus scores are given to these members.

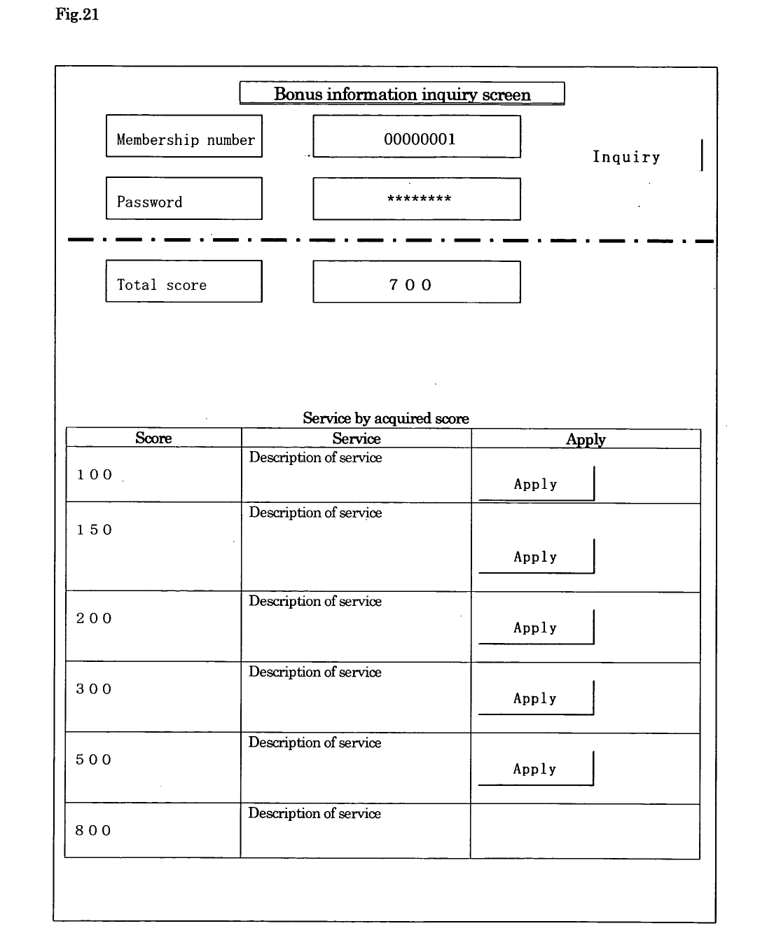

The bonus scores are registered in the membership information database. The details of the registration can be checked anytime on “Bonus information inquiry” page on the “Internet study abroad service” Web site. FIG. 21 shows an example of the bonus information inquiry screen. As shown in the diagram, the total score acquired and the descriptions of services available with the score are displayed. Applications for the services can be made online. Free bonuses available to members include free lesson courses, free access to the free-talk service, free tests for level check, free delivery of content, travel discount tickets, and free gifts.

Mail describing free bonuses available to members may be sent automatically when predetermined bonus scores are achieved. The mail may include the URL for accessing the foregoing Web site. Applications for the free bonuses may be accepted automatically by reply mail. In particular, it is highly effective to deliver mail that indicates the occurrence of bonus points actively and automatically in promotion periods. As described above, it is possible to give incentives for enrollment promotion, skill improvement, and other occurrences by providing members with the free bonus scoring system and actively informing them of how many bonus scores are accumulated and that free bonuses are available.

### 2. Service Assist System

The service assist system 52 is provided for efficient service provision of the “Internet study abroad service.”

(1) Course Registration Function

Accepts registration for courses for members to take, from a “Course registration” page on the “Internet study abroad service” Web site. The accepted courses are coded and registered into a course registration database. The courses may be provided by country, by language, and by theme. Available themes include business, travel conversation, qualifications, interpretation, and translation.

(2) Lesson Reservation Function

The service assist system 52 includes an instructor management file and a resource management file. The instructor management file manages the schedules of the instructors. The resource management file manages a conference schedule set in the bidirectional communication server 10, the use schedules of the instructor terminals 30, a delivery schedule set in the content delivery server 12, and other schedules. In response to applications for lessons from the members, the service assist system 52 consults these files to check for the availability of the bidirectional communication server 10 for conferences, the availability of the instructor terminals, and the availability of the content delivery server 12 for content delivery. Then, the service assist system 52 retrieves lessons available to the members based on their certified levels of the level check tests to be described later, and presents the same to the members. Here, lessons within certain zones of levels with respect to the respective certified levels are made available. Consequently, the members can adjust the difficulty levels according to their own progress. When the members reply for the lessons, the lessons are registered into lesson reservation transactions. The instructor management file and the resource management file are also updated in association with the lesson settings. In this manner, the instructor schedules and the resource availabilities are determined automatically for efficient reservation management.

At the time of lesson reservation, a service optimization condition file is consulted to optimize the lesson settings. The service optimization condition file includes items or conditions such that a plurality of members taking the same service are grouped by certain ranges of age, gender, and area, different instructors are assigned to a member who receives continuous services on the same day, and members are grouped by level based on the evaluations of the level check tests. These determinations are made by consulting the membership information database, the instructor management file, and the kartes of the members based on the predetermined conditions. Since lesson reservations are made with reference to the service optimization condition file, it is possible to provide optimum lessons for the members.

The applications for lessons may be made in any of dial mode, Web mode, and interactive mode. In dial mode, the members call the bureau and input numbers for application according to voice guidance. In Web mode, applications are made from a “lesson reservation” page on the “Internet study abroad service” Web site. In interactive mode, applications are made by using the bidirectional communication server 10.

Incidentally, lesson reservations made previously can also be cancelled by modifying the lesson reservation transactions, the instructor management file, and the resource management file based on the details of reception.

The foregoing preferred embodiment describes the case where lessons are assigned in response to member applications automatically with reference to the instructor management file and the resource management file. However, the present invention is not limited thereto. An annual lesson schedule may be established in advance such that member applications are accepted to this schedule, and lesson reservation transactions are issued based on the results of reception.

(3) Level Check Test Reservation Function

Members can take level check tests upon course registration and by recommendation of instructors.

Level check tests may be conducted in any of face-to-face mode, automatic mode, and mail mode. In face-to-face mode, the bidirectional communication server 10 is used to run tests face-to-face in the presence of an instructor. In automatic mode, the member answers to content delivered from the content delivery server 12 by button operations in the absence of aninstructor. In mail mode, questions are delivered and answers are accepted by e-mail.

For the level check tests in face-to-face mode and automatic mode, the same processing as with lesson reservations is performed for reservation, whereby level check test reservation transactions are issued. In the case of mail mode, a question mail including predetermined questions is delivered automatically.

The foregoing preferred embodiment describes the case where lessons and level check tests require prior reservations. However, the present invention is not limited thereto. Whether lessons and level check tests are available or not may be determined upon applications from members with reference to the instructor management file and the resource management file, such that the services for the lessons and level check tests are set when available. This makes it possible for the members to apply for lessons and take level check tests without reservation.

(4) Karte Management Function

Kartes are issued for members who are registered in service courses, whereby the history of lesson attendance and the history of participation of level check tests are recorded.

The karte contains the following information.

(i) Lesson Attendance History

For each lesson, the karte lists the name, date, evaluations, and other information regarding an attended lesson. The evaluation items include speaking ability, pronunciation, listening comprehension, vocabulary, and grammatical competence in five grades each. No evaluation value will be entered for evaluation items irrelevant to the lesson.

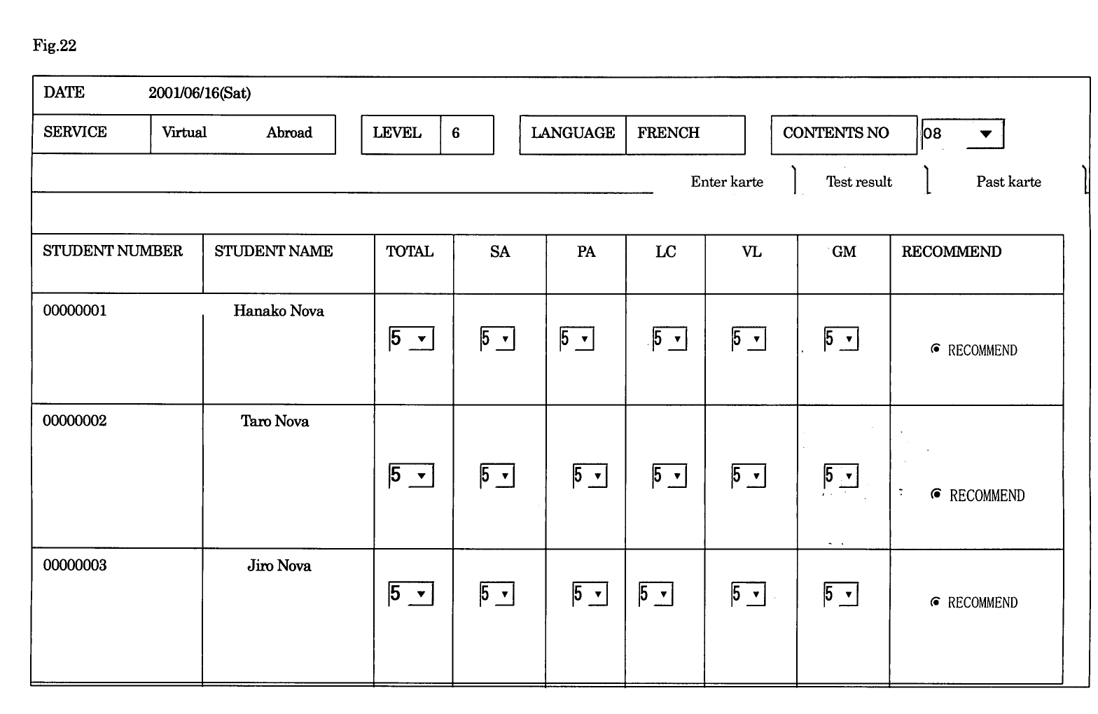

In face-to-face services, the evaluations are entered in principle by the end of the lesson by the instructor in charge. FIG. 22 shows an example of a karte entry screen.

In automatic services, quiz content is delivered at the end of the lesson, and the students enter answers by button operations. The service assist system 52 rates the answers with reference to lesson evaluation automatic rating files, which describe the correspondence between answers and evaluations, and inputs the ratings into the karte automatically. Evaluations are thus made even in automatic services, enabling detailed additional instruction for members.

(ii) Level Check Test Execution History

For each level check test, the karte lists the name and date of the test executed, the name of the recommending instructor, evaluations, and other information. The evaluation items are the same as those of the lesson evaluation described above. In face-to-face tests, evaluations are entered in principle by the instructors who give the tests.

In automatic tests and mail tests, the members enter answers by button operations or by e-mail. The service assist system 52 rates the answers with reference to level check evaluation automatic rating files, which describe the correspondence between answers and evaluations, and inputs the ratings into the karte automatically. This makes it possible to run level check tests without the intervention of instructors, thereby providing objective services with improved efficiency.

The service assist system 52 also certifies the levels of the members based on the results of the level check tests. For this certification, a certification condition table is consulted to average the evaluation values of the individual evaluation items with weights and determine certification levels. The certification levels are classified into the following nine levels: level 1 is equivalent to the level of native speakers; level 2 of foreign language specialist; level 3 sufficient for business use; level 4 for daily life; level 5 capable of some communication; level 6 capable of replies in simple sentences; level 7A capable of minimum communication; level 7B capable of greeting and self introduction; and level 7C an absolute beginner. As described above, the service assist system 52 sets certification levels automatically under definite rules, based on the results of the level check tests. This precludes differences among individual evaluators, and thus, enables objective decisions. It is also possible to lighten the burden on the instructors for more efficient administration.

Incidentally, the results of the level check tests and the certification levels granted are automatically e-mailed to the members.

(5) Personal Training Point Report Creation Function

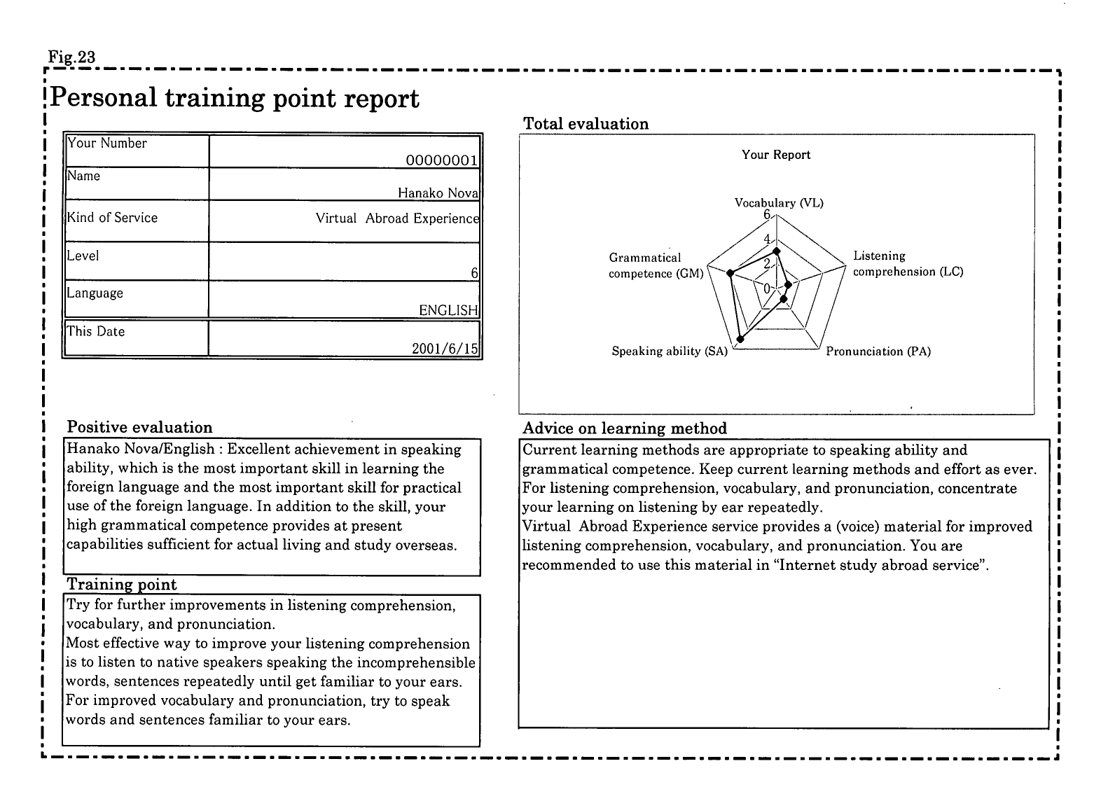

Personal training point reports contain total evaluation, positive evaluation, training points, advise on learning methods, and other information. The personal training point reports are delivered by e-mail to members as a free bonus service. FIG. 23 shows a sample of the personal training point report. As shown in the diagram, the total evaluation is shown in a radar chart. The advice on learning methods, the positive evaluation, and the training points are provided in text form.

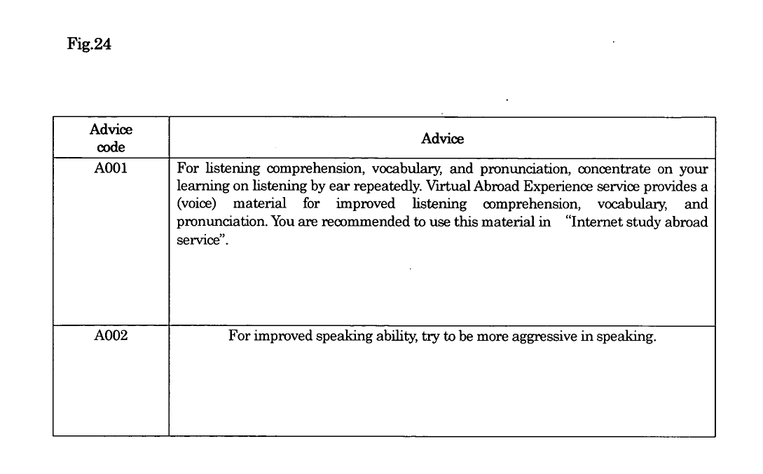

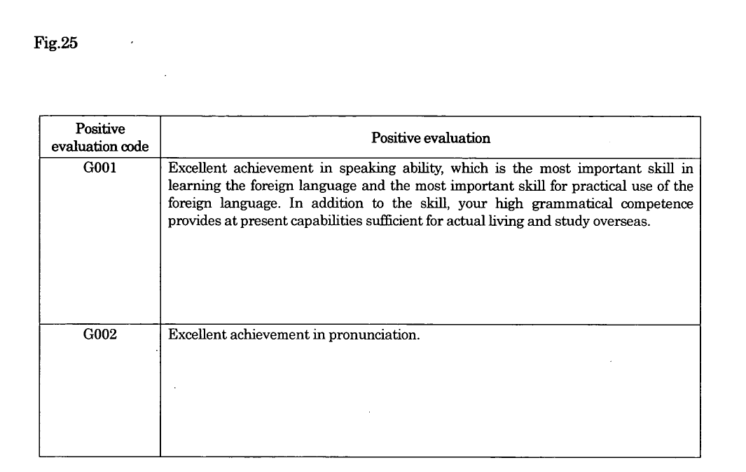

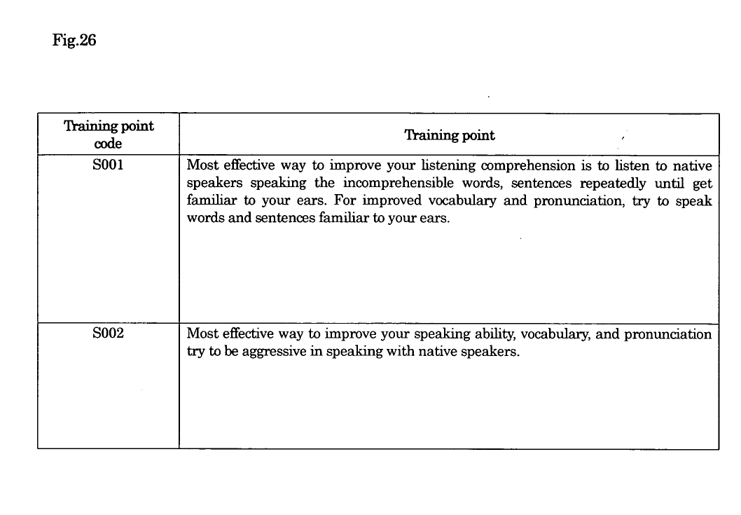

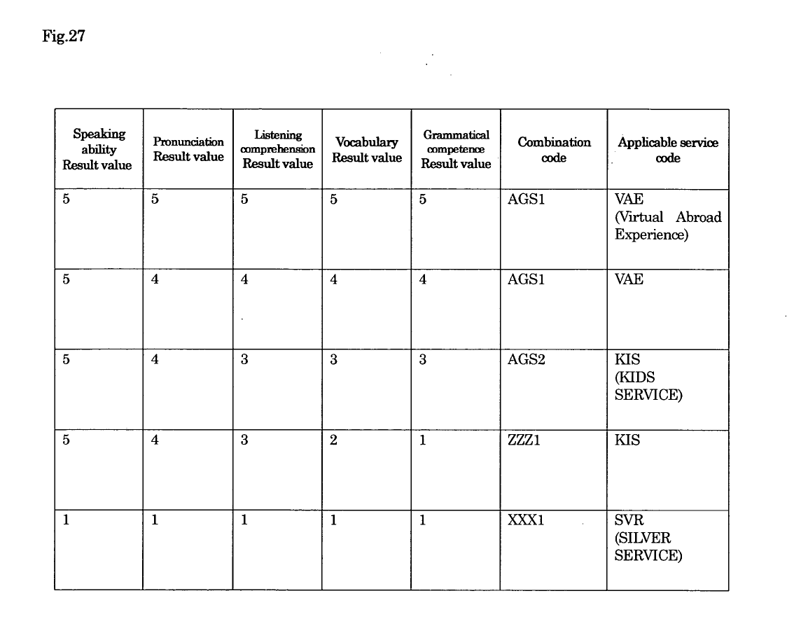

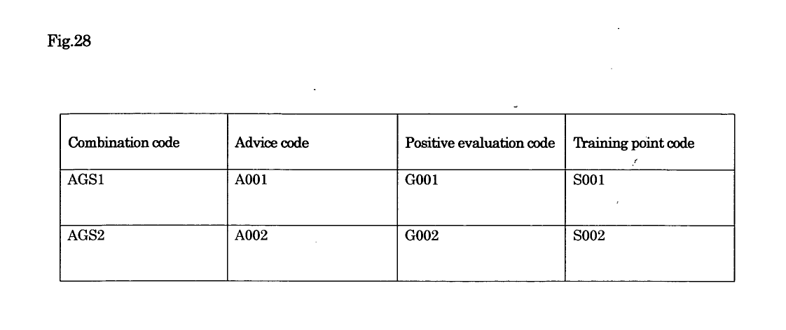

The educational service system creates an personal training point report automatically from karte data with reference to training point report creation tables. The training point report creation tables provided for this purpose include a learning method advice table, a positive evaluation table, a training point table, an evaluation value combination table, and a comment combination table. The learning method advice table, the positive evaluation table, and the training point table include comments for the fields of advice on learning methods, positive evaluation, and training points, respectively. The evaluation value combination table is intended to determine the reference addresses of the three tables from the evaluation value. FIG. 24 shows examples of the comments included in the learning method advice table, FIG. 25 shows examples of the comments included in the positive evaluation table, FIG. 26 shows examples of the comments included in the training point table, FIG. 27 shows an example of the evaluation value combination table, and FIG. 28 shows an example of the comment combination table.

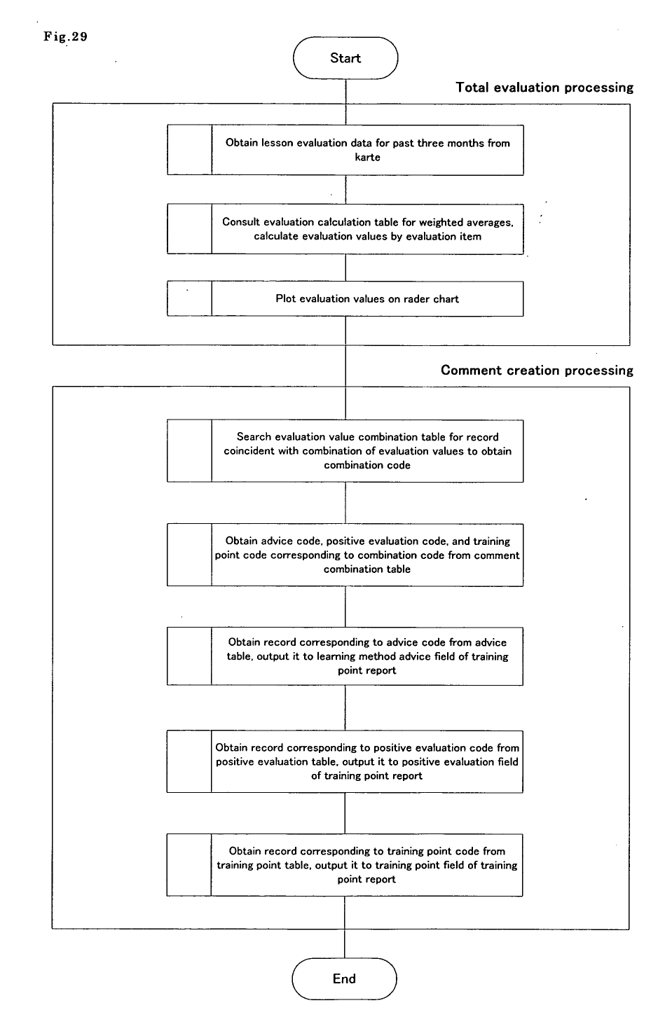

FIG. 29 shows the processing flow of the personal training point report automatic creation function. As shown in the flowchart, total evaluation processing is performed initially. In the total evaluation processing, lesson evaluation data is obtained from the karte for past three months. With reference to an evaluation calculating table which defines weights corresponding to lesson types, the lesson evaluation data is averaged with weights to calculate the evaluation values of the respective evaluation items. The calculated evaluation values are plotted on the radar chart.

Next, the process of creating comments on the training point report is performed. In the comment creation process, the evaluation value combination table is searched for a record coinciding with the combination of the evaluation values, whereby a combination code is obtained. Based on the obtained combination code, the comment combination table is consulted to obtain an advice code, a positive evaluation code, and a training point code. The advice table, the positive evaluation table, and the training point table are consulted by the advice code, the positive evaluation code, and the training point code obtained, respectively, whereby records of the corresponding comments are obtained. The obtained records are output to a learning method advice field, a positive evaluation field, and a training point field of the training point report, respectively.

This provides information regarding the members' lesson attendances and progress of lesson evaluations and level check evaluations. It is therefore possible to enhance the members' motivation and prevent discouragement which results from sluggish growth.

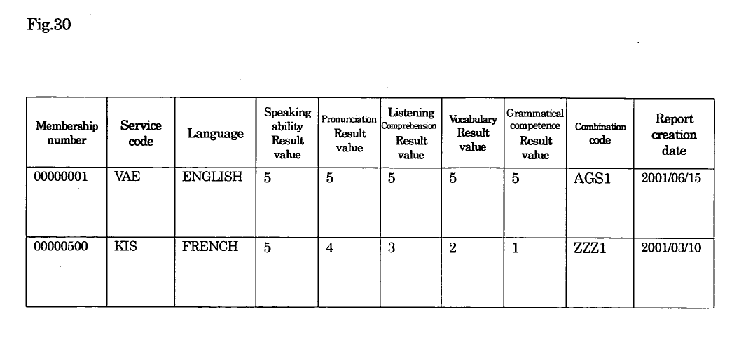

The foregoing preferred embodiment describes the case where personal training point reports are created from past karte information directly. Nevertheless, as shown in FIG. 30, a training point report issuing file may be created to record the calculations of the respective evaluation points and the combination codes for creating corresponding comments. In this case, the personal training point reports are created based on the file at the time of delivery to the members.

(6) Individual Educational Plan Creation Function

The educational service system creates a recommended educational plan for each individual automatically from past lesson evaluation data recorded in the karte. A training lesson table, a lesson pattern table, and an educational pattern determination table are used for this purpose. The training lesson table defines training lessons for low-rated evaluation items. The lesson pattern table defines combinations of training lessons' The educational pattern determination table determines an educational pattern for use based on the combination of the respective evaluation values. The evaluation values are those used in the personal training point reports, obtained from lesson evaluations for past three months.

Hereinafter, description will be given of an example where items of three smallest evaluation values are extracted to present a six-lesson plan. Suppose X, Y, and Z are lessons for training the extracted items of low evaluations, respectively. Then, the education plan to be presented is selected from among the following educational plans: (a) one-item intensive type (XXXXXX); (b) two-item intensive type (XXXYYY); (c) three-item intensive type (XXYYZZ); (d) two-item alternate type (XYXYXY); (e) three-item alternate type (XYZXYZ); (f) modified two-item intensive type 1 (XXXXYY); (g) modified two-item intensive type 2 (XXXXXY); (h) modified three-item intensive type 1 (XXXYYZ); (i) modified three-item intensive type 2 (XXXXYZ); (j) modified three-item alternate type 1 (XYZXYX); (k) modified three-item alternate type 2; and

(1) Modified Three-item Alternate type 3.

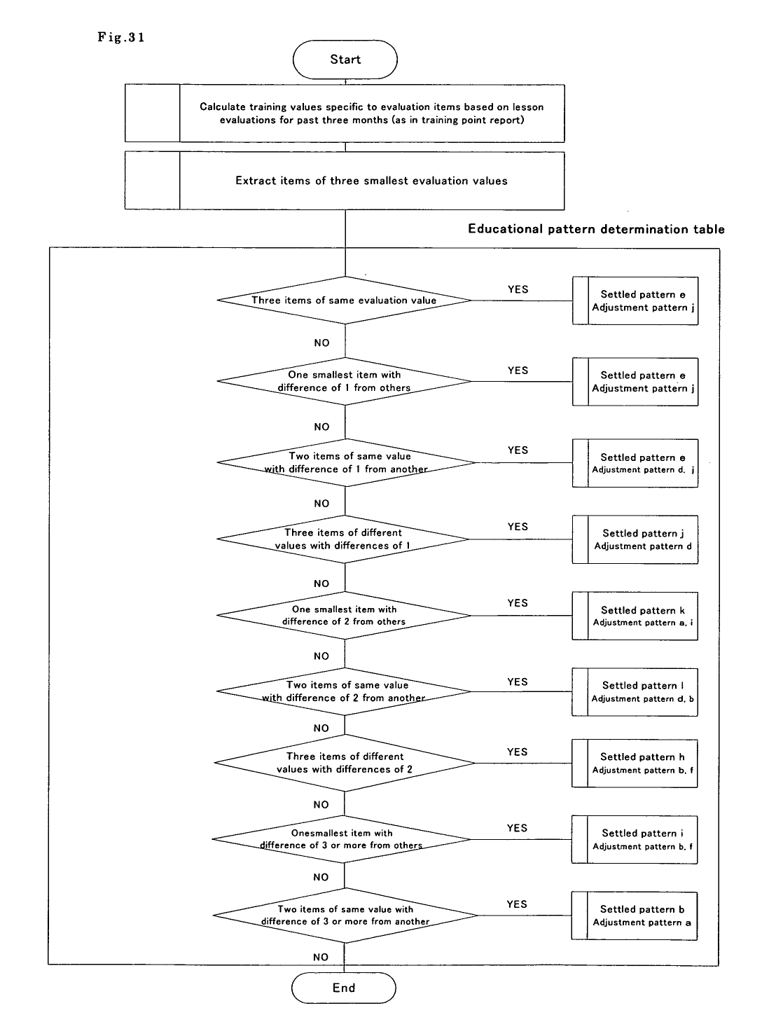

Which educational plan to select depends on the educational pattern determination table which defines the relationship between combinations of evaluation values and educational patterns. FIG. 31 shows the educational pattern determination table in the form of a process flow. For example, as shown in the chart, when the three items have the same evaluation value, the patterns (e) and (j) are selected as a determined pattern and an adjustment pattern, respectively. Here, the determined pattern is presented as a recommended lesson plan. The adjustment plan is one to which the determined pattern is switched dynamically in the case of poor outcomes after the start of the lessons.

The determined and adjustment patterns are also selected similarly for the rest of the combinations of evaluation values shown in the chart, respectively.

Based on the educational pattern determined by the educational pattern determination table, corresponding training lessons are extracted from the training lesson table. The combination of the extracted training lessons is presented as the recommended educational plan.

The created educational plan for each individual may be included in the personal training point report or delivered to the member independently.

The educational plan may also be presented at the time of lesson reservation, thereby promoting reservation determinations and automating reservations.

Consequently, appropriate lesson course plans are created automatically without a burden on instructors. It is therefore possible to provide the members with detailed instruction, contributing to improved skills of the members.

The foregoing preferred embodiment describes the case where the items of three smallest evaluation values are extracted to present a six-lesson plan. However, the present invention is not limited thereto. Educational plans can be similarly created automatically as long as an educational pattern table and educational pattern determination logic corresponding to the number of items and the number of lessons to present are provided.

(7) Additional Instruction Target Extraction Function

The educational service system extracts members who consume services inactively and who show sluggish improvement in level automatically based on the kartes, and delivers mail to those members.

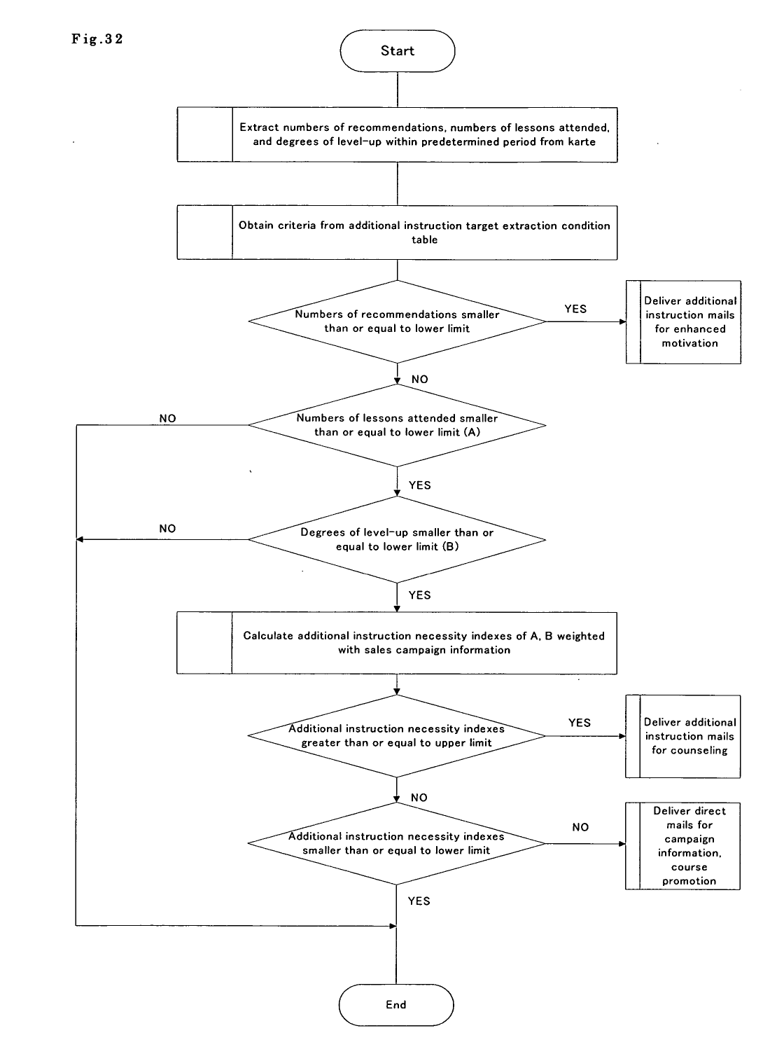

FIG. 32 shows the processing flow of the additional instruction target extraction function. As shown in the chart, the numbers of recommendations, the numbers of lessons attended, and the degrees of level-up within a predetermined period are extracted from the kartes. Then, criteria are obtained from an additional instruction target extraction condition table. If the numbers of recommendations do not exceed a lower limit, additional instruction mails are delivered for enhanced motivation. The numbers of lessons attended and the degrees of level-up are compared with respective lower limits, and if necessary, additional instruction necessity indexes are calculated with weights based on sales campaign information. If the additional instruction necessity indexes reach or exceed an upper limit, additional instruction mails are delivered to promote counseling. In addition, if the additional instruction necessity indexes are above a lower limit, direct mails are sent for campaign information or course promotion.

In the foregoing preferred embodiment, the numbers of recommendations, the numbers of lessons attended, and the degrees of level-up are used as the conditions for extracting additional instruction targets. However, the present invention is not limited thereto. Any of the items in the kartes may be used for the determination. In this case, determination items, determination conditions, and the details of the processing when the determination conditions are met can be listed in the additional instruction target extraction condition table, such that the processing is performed based on the same.

Consequently, the periodic automatic extraction of additional instruction targets and the notification to the members prevents the members from being discouraged and gives motivation for further learning. In addition, sales information can be considered in the determination, and the degree of necessity of additional instruction can be determined to modify the notification. This provides more detailed instruction for the members.

### 3. Service Executive Control System

The service executive control system 54 manages the execution of lessons and level check tests set by the service assist system 52.

(1) Lesson Executive Management Function

With reference to lesson reservation transactions, the lesson executive management function requests the bidirectional communication server 10 to set a conference room, and posts the addresses of student terminals and instructor terminal to connect a predetermined time before a lesson reservation. The bidirectional communication server 10 thus sets a conference room, and accepts connection requests from the student terminals and instructor terminal notified.

At lesson start time, the service executive control system 54 posts the addresses of the student terminals and instructor terminal as destinations of delivery to the content delivery server 12, thereby submitting preparation for delivery. Consequently, in the case of interactive services, the content delivery server 12 informs the instructor terminal that the preparation for delivery is completed, and starts delivery under a delivery start instruction from the instructor terminal. In the case of automatic services, the content delivery server 12 informs the student terminals that the preparation for delivery is completed, and starts delivery under delivery start instructions from the student terminals.

(2) Level Check Test Executive Management Function

Level check tests are conducted by performing the same processing as described above with reference to the level check test transactions.

### 4. Delivery Service Management System

The delivery service management system 56 exercises centralized control over mail delivery for registered members.

The mail delivery covers the confirmation mails concerning the registration and modification of member information, the notification of bonus scores, the results of the level check tests, the training point reports, and the notification of additional instruction targets described thus far, as well as educational materials for preparation and review requested by members.

Moreover, direct mails concerning various events, promotion information, and other information are also delivered.

In the foregoing preferred embodiment, the Internet is used as the communication lines. The services are thus available to remote locations anytime without worry about telephone bills. The foregoing preferred embodiment describes the case where the instructor uses a user terminal in the educational service center. Nevertheless, the present invention is not limited thereto, and the instructor may use a user terminal connected to the Internet. This can be achieved by setting a chairpersonship flag for a certain user terminal as described above. Consequently, as long as an Internet-accessible user terminal is available, the instructor can provide services from anywhere at anytime. This enables more flexible services. Since the instructor in foreign countries can participate, language education by native speakers is promoted.

The foregoing preferred embodiment describes the case where the Internet is used as the communication lines. However, the present invention is not limited thereto. Telephone lines may be used to connect to the educational service center directly.

Alternatively, LAN, WAN, and other networks may be used in such applications as corporate education and school education. The present invention also provides the same benefits even when used for educational services to be provided in a certain group. Needless to say, the communication lines are not limited to wired ones, but may also be wireless ones.

The present invention is also applicable to situations where the educational service center has booths for providing service. Combinations of interactive services and automatic services can thus be provided to offer services using a variety of multimedia educational materials while enabling an instructor to control a plurality of services which reduces personnel cost.

The foregoing preferred embodiment describes the case where the user terminals used by the members are personal computers having an interface function for a TV camera and a microphone, and an Internet connection function. Nevertheless, any kind of terminal can be used as long as it is connectable to the communication lines and has the interface function for a TV camera and a microphone. Available terminals include PDAs, game consoles, and other mobile terminals aside from dedicated terminals. Such devices as a cellular phone with a TV camera are also expected to be available in the future, and full use of such devices will widen the range of target users.

As has been described, the educational service system according to the present invention includes bidirectional communication device for conducting bidirectional communication using multimedia information including TV pictures and sounds, content management device for storing multimedia content to be used as educational materials, and the content delivery device for delivering the content stored in the content management device to user terminals. The multimedia content stored in advance can be retrieved and delivered such that the user terminals engage in a conversation while receiving the multimedia content, with greatly improved educational results.

The present invention is not limited to each of the above-described preferred embodiments, and various modifications are possible within the range described in the claims. An embodiment obtained by appropriately combining technical features disclosed in each of the different preferred embodiments is included in the technical scope of the present invention.

1. An educational service system using communication lines for providing an interactive educational service between a plurality of user terminals connected to the communication lines, the educational service system comprising:
a bidirectional communication device for conducting bidirectional communication between the user terminals, using multimedia information including at least TV pictures and sounds;
content management device for storing multimedia contents to be used as educational materials; and
content delivery device for delivering the contents stored in the contents management device to the user terminals.

2. An educational service providing method employing the educational service system using communication lines according to claim 1, comprising the steps of:
receiving TV pictures and sounds transmitted from the user terminals;
synthesizing the TV pictures and sounds received;
transmitting the synthesized TV pictures and sounds to the user terminals;
storing multimedia contents to be used as educational materials;
retrieving the stored content; and
delivering the retrieved content to the user terminals.

3. The educational service providing method according to claim 2, wherein:
the step of storing contents includes the steps of storing material content, and storing a scenario defining a combination of the material contents along a time axis; and
the step of delivering content includes the steps of retrieving the stored material content based on the stored scenario, and delivering the retrieved material content.

4. An educational service providing method employing the educational service system using communication lines according to claim 1, comprising the steps of:
establishing a service menu combining a face-to-face service for effecting face-to-face learning by the bidirectional communication device with an assigned instructor and an automatic service for effecting learning under content delivery by the content delivery device with no assigned instructor; and
providing services based on the established service menu.

5. An educational service providing method employing the educational service system using communication lines according to claim 1, comprising the steps of:
displaying information registered in a membership information file onto an authenticated user terminal, the membership information file containing personal information on members;
acquiring personal information to be registered or updated from the user terminal;
confirming with the user terminal permission to register the acquired personal information into the membership information file; and
recording the confirmed personal information into the membership information file.

6. The educational service providing method using communication lines according to claim 5, wherein the step of confirming permission to register includes the steps of delivering a confirmation mail to the user, accepting a reply mail to the confirmation mail, and analyzing the accepted reply mail.

7. An educational service providing method employing the educational service system using communication lines according to claim 1, comprising the steps of:
adding a predetermined score to a score of a member in a bonus score file when the member satisfies a predetermined bonus score occurring condition, the bonus score file accumulating the score for the member to receive a bonus service with;
notifying the member of the accumulated bonus score and of a free bonus available; and
applying for a free bonus based on the notification.

8. An educational service providing method employing the educational service system using communication lines according to claim 1, comprising the steps of:
delivering contents for lesson evaluation to the user terminals;
acquiring answers to the delivered content from the user terminals; and
calculating lesson evaluations from the acquired answers.

9. An educational service providing method employing the educational service system using communication lines according to claim 1, comprising the steps of:
delivering contents for a level check test to the user terminals;
acquiring answers to the delivered content from the user terminals; and
calculating level check evaluations from the acquired answers.

10. An educational service providing method employing the educational service system using communication lines according to claim 1, comprising the steps of:
recording lesson description and lesson evaluation into a karte file lesson by lesson, the karte file containing lesson histories member by member; and
recording level check evaluations into the karte file upon each level check test.

11. The educational service providing method using communication lines according to claim 10, further comprising the steps of:
providing a training point report creation table for defining the relationship between lesson evaluations and descriptions in a personal training point report;
retrieving past lesson evaluation data recorded in the karte file; and
creating a training point report from the retrieved past lesson evaluation data with reference to the training point report creation table.

12. The educational service providing method using communication lines according to claim 10, further comprising the steps of:
providing an educational pattern determination table for determining an educational pattern from evaluation values on evaluation items, and a lesson table for registering a lesson to be attended with respect to each of the evaluation items;
past lesson evaluation data recorded in the karte file;
extracting an item of low evaluation from the extracted lesson evaluation data; determining an educational pattern from the evaluation value of the extracted item with reference to the educational pattern determination table; and
combining lessons based on the determined educational pattern with reference to the lesson table.

13. The educational service providing method using communication lines according to claim 10, further comprising the steps of:
providing an additional instruction target extraction condition table for extracting a member in need of additional instruction; and
retrieving data from the karte file;
extracting an additional instruction target from the retrieved data of the karte file with reference to the additional instruction target extraction condition table; and
notifying the extracted member.
